(19) United States
(12) Patent Application Publication
(10) Pub. No.: US 2014/0248513 A1
(43) Pub. Date: Sep. 4, 2014

(54) MAGNETIC RECORDING MEDIUM, METHOD FOR PRODUCING THE SAME, AND METHOD FOR PRODUCING STAMPER

(71) Applicant: KABUSHIKI KAISHA TOSHIBA, Tokyo (JP)

(72) Inventors: Kazutaka Takizawa, Kawasaki-shi (JP); Akira Watanabe, Kawasaki-shi (JP); Kaori Kimura, Yokohama-shi (JP); Tsuyoshi Onitsuka, Hino-shi (JP); Takeshi Iwasaki, Inagi-shi (JP); Akihiko Takeo, Kokubunji-shi (JP)

(21) Appl. No.: 13/941,202

(22) Filed: Jul. 12, 2013

(30) Foreign Application Priority Data
Mar. 1, 2013 (JP) 2013-041232

(51) Int. Cl. G11B 5/74; G11B 5/84

(52) U.S. Cl. CPC G11B 5/743; G11B 5/84
USPC 428/835; 430/320; 428/834; 205/70

(57) ABSTRACT

According to one embodiment, there is provided a method for producing a magnetic recording medium which includes forming a mask layer on a magnetic recording layer, applying metal fine particles on the mask layer, covering the metal fine particles with an overcoat layer, irradiating with energy beams through the overcoat layer so as to deactivate a protective coating of the metal fine particles, transferring a metal fine particle pattern from the mask layer to the magnetic recording layer, and removing the mask layer from the magnetic recording layer.

### CROSS-REFERENCE TO RELATED APPLICATIONS

This application is based upon and claims the benefit of priority from Japanese Patent Application No. 2013-041232, filed Mar. 1, 2013, the entire contents of which are incorporated herein by reference.

### FIELD

Embodiments described herein relate generally to a magnetic recording medium, a method for producing a magnetic recording medium, and a method for producing a stamper.

### BACKGROUND

With a significant increase in the amount of information, there is an eager demand for the realization of a large volume information recording apparatus. In the hard disk drive (HDD) technology, a high recording density is achieved. Thus, various techniques concentrating on perpendicular magnetic recording have been developed. Further, a patterned medium is suggested as a medium which satisfies both the improvement in recording density and the thermal fluctuation resistance. The technique for manufacturing the medium has been actively developed.

The patterned medium records one or more magnetic areas as one cell. In order to record 1-bit information in one cell, it is possible that recording cells are magnetically separated. Therefore, a magnetic dot portion and a nonmagnetic portion are formed on the same flat surface using a fine processing technology. A fine concave-convex pattern is formed on a magnetic recording layer formed on a substrate using a semiconductor manufacturing technology. Then, the pattern is physically divided to obtain magnetically independent patterns.

In order to form a magnetic dot pattern, a mask is previously formed on a magnetic film so that the concave-convex pattern can be transferred. Alternatively, the concave-convex pattern is formed on a mask material and then ions irradiated with high energy are injected into the magnetic area so that the pattern can be selectively deactivated. Further, a concave-convex mold is pressed against a resist material so that the concave-convex pattern can also be transferred.

It is necessary to reduce the pitch of the magnetic dots in order to realize a high recording density of the patterned medium, and thus a fine mask for processing is needed. In order to respond to this situation, there is a technology of using metal fine particles as the mask pattern, in addition to existing technologies such as ultraviolet ray exposure and electron beam exposure.

When the metal fine particles are used as a mask for processing, a dispersion prepared by dispersing a metal fine particle material in a solvent is usually used. Then, the pattern is transferred using the metal fine particles as the mask after the coating so that an independent concave-convex pattern can be obtained. Further, etching processing is performed using the metal fine particles as a convexo-concave mask so that the pattern can be transferred to a lower layer. It is possible that the variation of the size of the magnetic dots to be produced in a large area on the substrate is lower and defects are fewer. Therefore, it is possible that the metal fine particles are independently present on the substrate. The metal fine particles to be used have a protective coating thereon and are physically and chemically isolated from other adjacent metal fine particles. Accordingly, in the dispersion system, the aggregation of the metal fine particles is suppressed. However, when the etching processing is performed using the metal fine particles as the convexo-concave mask, the protective coating at the periphery of the metal fine particles is lost due to the plasma damage generated during etching. The metal fine particles are aggregated with other adjacent metal fine particles, and in-plane variations in the concave-convex pattern are increased. Consequently, there have been problems such as deterioration in the uniformity of the transferred pattern and deterioration in the surface smoothness of the convexo-concave pattern.

Therefore, if etching is directly performed using a metal fine particles pattern as the mask, the uniformity of the transferred pattern is significantly worsened by the aggregation of fine particles. Additionally, the deterioration of HDI (Head Disk Interface) characteristics in the medium is unavoidable.

### BRIEF DESCRIPTION OF THE DRAWINGS

FIGS. 1A, 1B, 1C, 1D, 1E, 1F, 1G, 1H, 1I, and 1J are a view showing a production process of a magnetic recording medium according to a first embodiment;

FIGS. 2A, 2B, 2C, 2D, 2E, 2F, 2G, 2H, 2I, and 2J are a view showing a modification of the production process of the magnetic recording medium according to the first embodiment;

FIGS. 3A, 3B, 3C, 3D, 3E, 3F, 3G, 3H, 3I, 3J, and 3K are a view showing a production process of a magnetic recording medium according to a second embodiment;

FIGS. 4A, 4B, 4C, 4D, 4E, 4F, 4G, 4H, 4I, 4J, 4K, and 4L are a view showing a production process of a magnetic recording medium according to a third embodiment;

FIGS. 5A, 5B, 5C, 5D, 5E, 5F, 5G, 5H, 5I, 5J, and 5K are a view showing a production process of a magnetic recording medium according to a fourth embodiment;

FIGS. 6A, 6B, 6C, 6D, 6E, 6F, 6G, 6H, and 61 are a view for explaining an example of a method for producing a stamper;

FIGS. 7A, 7B, 7C, 7D, 7E, 7F, 7G, 7H, 7I, and 7J are a view for explaining another example of the method for producing a stamper;

FIGS. 8A, 8B, 8C, 8D, 8E, 8F, 8G, and 8H are a view for explaining another example of the method for producing the magnetic recording medium according to the first embodiment;

FIG. 9 is a view showing an example of a record bit pattern in a circumferential direction of a magnetic recording medium;

FIG. 10 is a view showing another example of the record bit pattern of the magnetic recording medium;

FIG. 11 is a perspective view of a partially disassembled of a magnetic recording/reproducing device to which the magnetic recording medium according to the embodiments can be applied;

FIG. 12 is a cross section TEM photograph showing a state of metal fine particles after irradiation with energy beams; and

FIG. 13 is an SEM photograph of the upper surface which shows the state of metal fine particles after irradiation with energy beams in FIG. 12.

### DETAILED DESCRIPTION

In general, according to one embodiment, a method for producing a magnetic recording medium according to the embodiment includes forming a magnetic recording layer on a substrate; forming a mask layer on the magnetic recording layer; forming a concave-convex pattern formed of a metal fine particle layer on the mask layer; transferring the concave-convex pattern formed of a metal fine particle layer to the mask layer; transferring the concave-convex pattern to the magnetic recording layer; and removing the mask layer from the magnetic recording layer.

The metal fine particle layer is formed of a plurality of metal fine particles coated with a protective coating.

The process of forming a concave-convex pattern formed of a metal fine particle layer on the mask layer includes forming a metal fine particle layer on a mask layer; forming an overcoat layer on the surface of the metal fine particle layer; and irradiating with energy beams to deactivate the protective coating.

The magnetic recording medium according to the embodiment is produced by the above method.

The method for producing a magnetic recording medium according to the embodiment can be divided into first to fourth embodiments.

A first embodiment includes transferring a concave-convex pattern to a mask layer, and removing a metal fine particle film and the mask layer after a process of transferring the concave-convex pattern to a magnetic recording layer.

A second embodiment includes forming a transfer layer on a mask layer before a process of forming a concave-convex pattern on the mask layer. The process of forming the concave-convex pattern on the mask layer further includes applying a metal fine particle coating liquid to a transfer layer in place of applying the metal fine particle coating liquid to the mask layer and forming an overcoat layer, irradiating with energy beams, and transferring a concave-convex pattern to the transfer layer before a process of transferring the concave-convex pattern to the mask layer.

A third embodiment includes removing a metal fine particle portion between a process of transferring a concave-convex pattern to a mask layer and a process of transferring the concave-convex pattern to a magnetic recording layer.

A fourth embodiment includes forming a release layer on a magnetic recording layer before a process of forming a mask layer on a magnetic recording layer, transferring a concave-convex pattern to the release layer before a process of transferring the concave-convex pattern to the magnetic recording layer, and peeling off the mask layer from the magnetic recording layer to remove the release layer after the process of transferring the concave-convex pattern to the magnetic recording layer.

According to the method for producing a magnetic recording medium according to the embodiments, even if the overcoat layer is formed on the surface of the metal fine particle layer and the protective coating on the metal fine particle surface is deactivated by irradiation with energy beams, the aggregation of the metal fine particles can be suppressed because the metal fine particle layer is sufficiently adhered to the surface of the mask layer. The aggregation of the metal fine particles is suppressed so that the positional dependence of the transfer accuracy of the concave-convex pattern can be reduced and a magnetic recording medium excellent in in-plane uniformity can be produced. The roughness difference between the concave-convex patterns of the metal fine particles which is caused by the aggregation of the metal fine particles can be reduced, and excellent surface flatness is obtained. Accordingly, the glide characteristics at the time of head scanning of the medium are improved. Further, a fine pattern usable for high recording density can be simply produced, and thus the production process can be simplified.

The overcoat layer used in the embodiments can cover the protective coatings on the surfaces of the metal fine particles. The top of the overcoat layer is irradiated with energy beams. The beams transmit through the overcoat layer and reach the protective coatings and the metal fine particles. Alternatively, the overcoat layer covers the surfaces of the metal fine particles arranged on the substrate and the protective coatings. In this case, the gaps among the protective coatings can be filled.

The thickness of the overcoat layer may be from 0.5 to 10 nm or less. If the thickness exceeds 10 nm, the energy beams tend to be hardly transmitted through the layer. If the thickness is less than 0.5 nm, it tends to be difficult to achieve uniform coatability on the metal fine particles.

The metal fine particles used in the embodiments may be selected from fine particles of metal simple substances such as carbon, aluminium, silicon, titanium, iron, cobalt, nickel, copper, zinc, zirconium, molybdenum, ruthenium, palladium, silver, tantalum, tungsten, platinum, gold, and cerium; fine particles of alloys of the simple substances; and fine particles of compounds of the simple substances. A coating liquid containing metal fine particles in a solvent is coated by various method such as spin-coating, dip-coating, spin-casting, Langmuir Blodgett technique, and ink-jetting.

A concave-convex pattern of metal fine particles can be transferred to the mask layer by etching. According to a third embodiment, in this case, a transfer layer can be formed between the metal fine particles and the mask layer in order to improve the transfer accuracy of the pattern.

After transferring the concave-convex pattern to the magnetic recording layer, the mask layer is removed from the top of the magnetic recording layer by etching. Alternatively, the release layer is previously formed on the magnetic recording layer, and the mask layer may be peeled off from the magnetic recording layer by the removal of the release layer. Dry etching or wet etching is used in the removal of the release layer.

The first to fourth embodiments can be performed in combination with one another.

Hereinafter, embodiments of the present invention will be described with reference to the drawings.

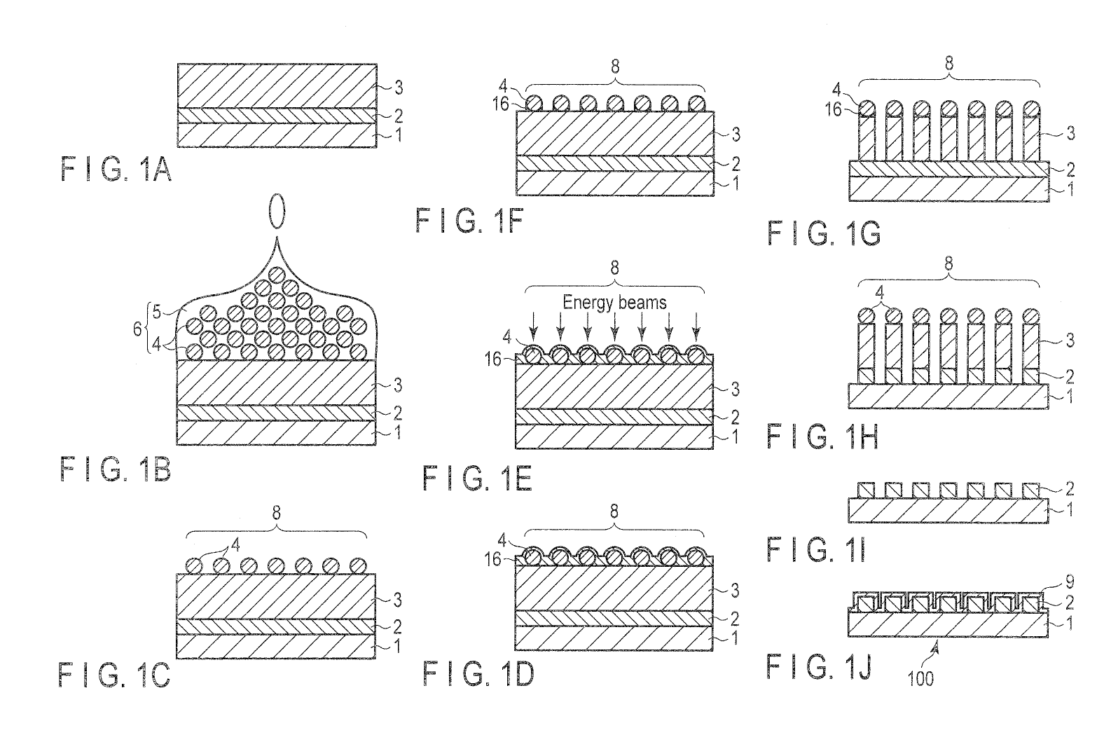

FIGS. 1A to 1J show the production process of the magnetic recording medium according to the first embodiment.

First, a magnetic recording medium having a magnetic recording layer on a substrate is prepared.

As shown in FIG. 1A, a mask layer 3 is formed on a magnetic recording medium 2 formed on a substrate 1.

Then, as shown in FIG. 1B, a metal fine particle coating liquid 6 which includes metal fine particles 4 coated with protective coatings (not shown) and a solvent 5 is dropped and applied onto a mask layer 3 to obtain a metal fine particle film 8 having metal fine particles regularly arranged as shown in FIG. 1C.

Subsequently, as shown in FIG. 1D, an overcoat layer 16 which covers the surface of the metal fine particle film 8 and the surface of the mask layer 3 having the metal fine particle film 8 formed thereon is formed.

Thereafter, as shown in FIG. 1E, the protective coatings on the surfaces of the metal fine particles 4 are deactivated by irradiating the metal fine particle film 8 with energy beams through the overcoat layer 16.

As shown in FIG. 1F, the concave-convex pattern of the metal fine particle film 8 is formed on the surface of the mask layer 3 by etching the overcoat layer 16 using the metal fine particle layer 8 as a mask.

Then, as shown in FIG. 1G, the concave-convex pattern formed of a single layer of the metal fine particle film 8 is transferred to the mask layer 3.

Subsequently, as shown in FIG. 1H, the concave-convex pattern is transferred to a magnetic recording layer 2 through a single layer of the metal fine particle film 8 and the patterned mask layer 3.

Further, as shown in FIG. 1I, the substrate 1 and the patterned magnetic recording layer 2 formed thereon are obtained by removing the mask layer 3 on the magnetic recording layer 2 and the single layer of the metal fine particle film.

As shown in FIG. 1J, a protective film 9 is formed on the patterned magnetic recording layer 2 to obtain a magnetic recording medium 100.

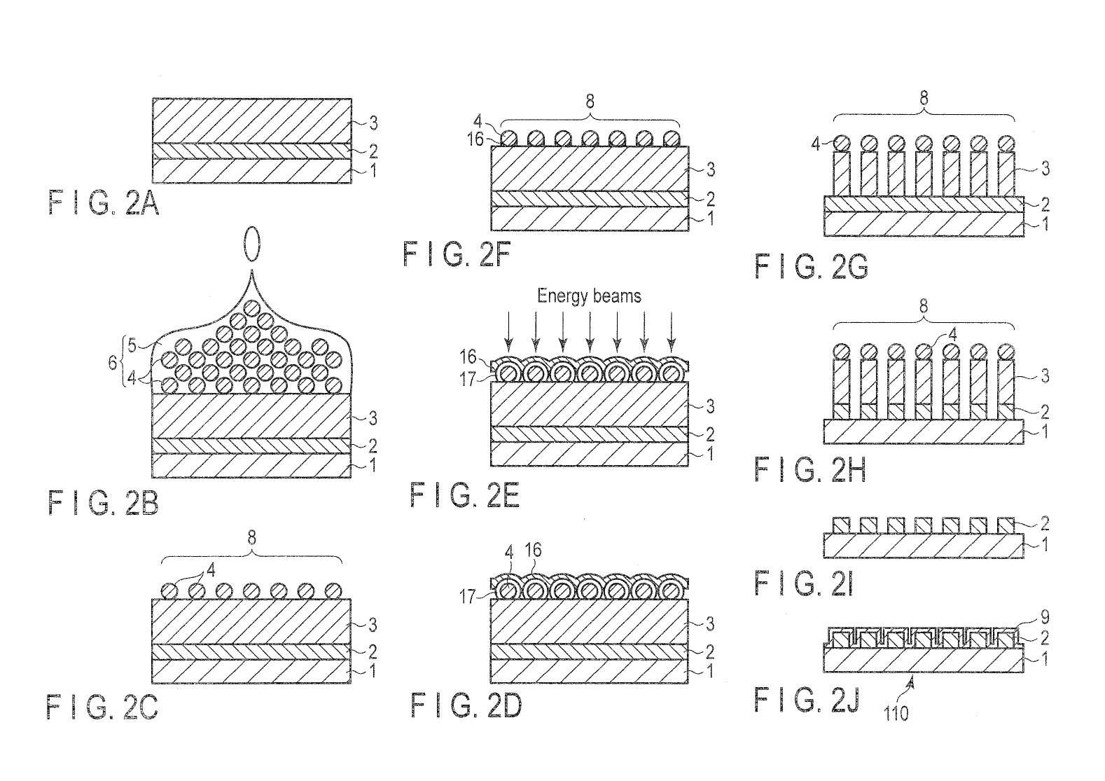

FIGS. 2A to 2J show a modification of the production process of the magnetic recording medium according to the first embodiment.

In the modification of the production process of the magnetic recording medium according to the first embodiment, a magnetic recording medium 110 can be produced similarly to FIGS. 1A to 1I except that the overcoat layer 16 which covers the metal fine particle layer 8 is formed on a protective coating 17 around the metal fine particles as shown in FIGS. 2D and 2E, in place of forming an overcoat layer 16 which covers the surface of a metal fine particle film 8 and the surface of a mask layer 3 having the metal fine particle film 8 formed thereon as shown in FIGS. 1D and 1E, and the overcoat layer is arranged on the surface of the mask layer 3 through the protective coating.

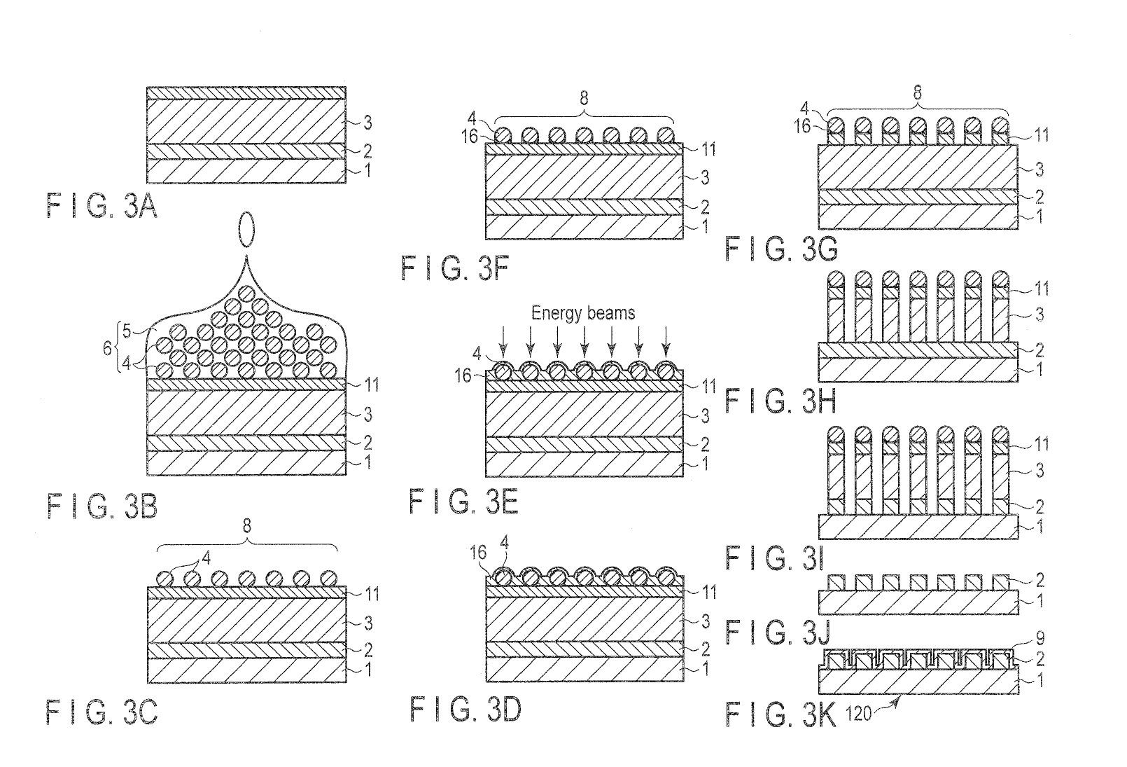

FIGS. 3A to 3K show the production process of the magnetic recording medium according to the second embodiment.

In the production process of the magnetic recording medium according to the second embodiment, as shown in FIG. 3A, a magnetic recording medium 120 can be obtained similarly to FIGS. 1A to 1J except that a transfer layer 11 is further formed on the mask layer 3 which is formed on the magnetic recording layer 2, a concave-convex pattern is transferred to the transfer layer 11 using a single layer of the metal fine particle film 8 as shown in FIG. 3G, and the concave-convex pattern of the transfer layer 11 is transferred to the mask layer 3 as shown in FIG. 3H.

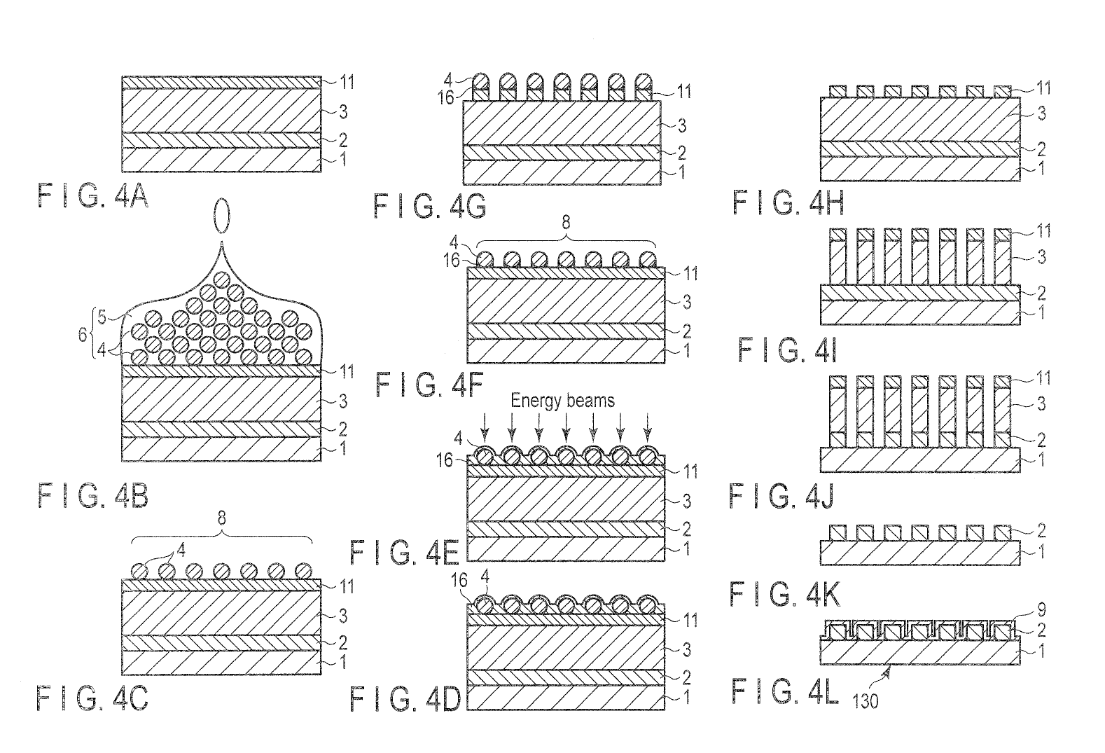

FIGS. 4A to 4I show the production process of the magnetic recording medium according to the third embodiment.

In the production process of the magnetic recording medium according to the third embodiment, a magnetic recording medium 130 can be obtained similarly to FIGS. 3A to 3K except that the process of removing the metal fine particle layer 8 as shown in FIG. 4H is provided between the process of transferring the concave-convex patterns of the metal fine particle layer 8 and the transfer layer 11 to the mask layer 3 as shown in FIG. 3H and the process of transferring the concave-convex patterns of the transfer layer 11 and the mask layer 3 to the magnetic recording layer as shown in FIG. 3I.

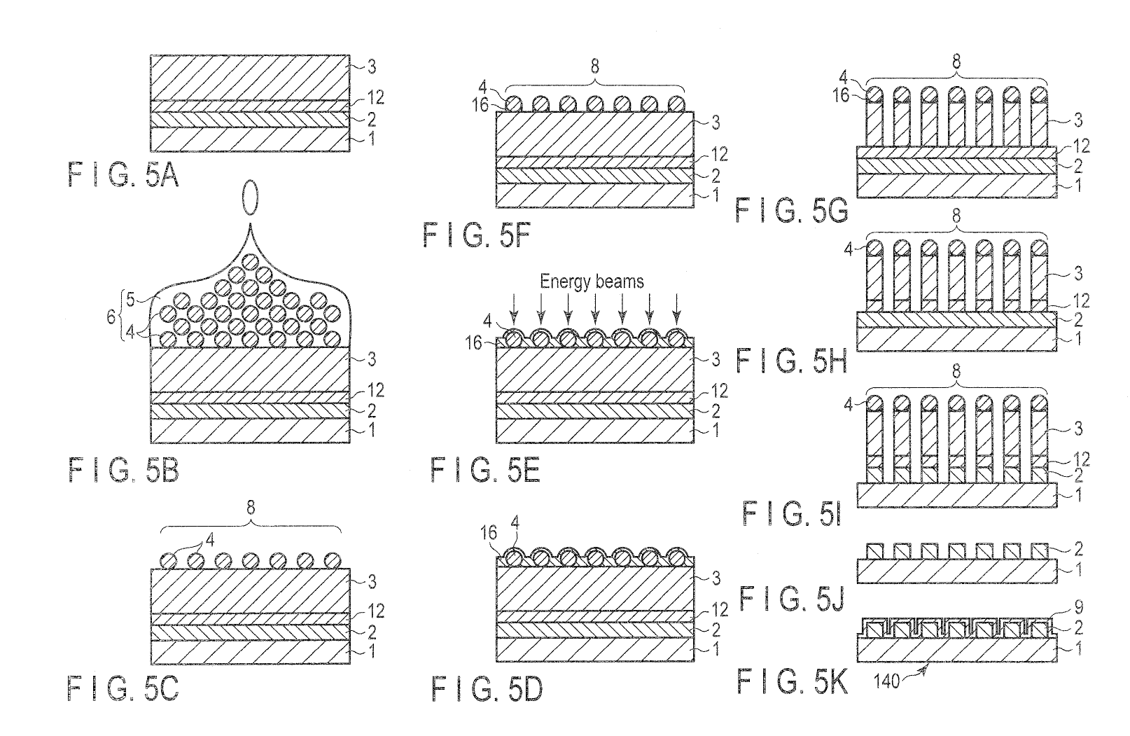

FIGS. 5A to 5K show the production process of the magnetic recording medium according to the fourth embodiment.

The magnetic recording medium 130 can be obtained similarly to FIGS. 1A to 1J except that a release layer 12 is further formed between the magnetic recording layer 2 formed on the substrate 1 and the mask layer 3 as shown in FIG. 5A, the concave-convex patterns of the metal fine particle layer 8 and the mask layer 3 are transferred to the release layer 12 before transferring them to the magnetic recording layer 2 as in FIG. 5H, and the mask layer 3 and the metal fine particle film 8 are peeled off from the magnetic recording layer 2 by removing the release layer 12 in place of the mask layer 3 in FIG. 5J.

Process of Forming Magnetic Recording Layer

First, a magnetic recording layer is formed on a substrate to obtain a magnetic recording medium.

There is no restriction on the shape of the substrate. Usually, a round and hard substrate is used. For example, a glass substrate, a metal-containing substrate, a carbon substrate, a ceramic substrate or the like is used. In order to make the in-plane uniformity of the pattern excellent, it is possible to reduce the concave-convex portions on the surface of the substrate. If necessary, it is possible to form a protective film like an oxide film on the surface of the substrate.

Amorphous glass represented by soda lime glass and aluminosilicate glass or crystallized glass represented by lithium-based glass may be used for the glass substrate. A sintered substrate which contains alumina, aluminum nitride, and silicon nitride as main components may be used for the ceramic substrate.

A magnetic recording layer having a perpendicular magnetic recording layer which contains cobalt as a main component is formed on the substrate.

Here, it is possible to form a soft under layer (SUL) having high magnetic permeability between the substrate and the perpendicular magnetic recording layer. The soft under layer shares responsibility for the magnetic recording head function of circulating a record magnetic field from a magnetic recording head which magnetizes the perpendicular magnetic recording layer. The recording/reproduction efficiency can be improved by applying a steep sufficient perpendicular magnetic field to the recording layer in the magnetic field.

For example, materials including Fe, Ni, and Co may be used for the soft under layer. Among those materials, amorphous materials which have no magnetocrystalline anisotropy, crystal defects, and grain boundary and exhibit excellent soft magnetism may be used. The low noise of the recording medium can be achieved by using a soft magnetic amorphous material. As the soft magnetic amorphous material, for example, an Co alloy which contains Co as a main component and contains at least one of Zr, Nb, Hf, Ti, and Ta (e.g., CoZr, CoZrNb, and CoZrTa) may be selected.

An underlayer can be formed between the soft under layer and the substrate to improve the adhesion of the soft under layer. As the underlayer material, Ni, Ti, Ta, W, Cr, Pt, alloys thereof, oxides thereof, and nitrides thereof may be used. For example, NiTa, NiCr, and the like may be used. These layers may be formed of a plurality of the materials.

Further, an intermediate layer of a non-magnetic metal material may be formed between the soft under layer and the perpendicular magnetic recording layer. The intermediate layer has two roles of blocking an exchange bonding interaction between the soft under layer and the perpendicular magnetic recording layer and controlling the crystallinity of the perpendicular magnetic recording layer. The material of the intermediate layer may be selected from Ru, Pt, Pd, W, Ti, Ta, Cr, Si, alloys thereof, oxides thereof, and nitrides thereof.

The perpendicular magnetic recording layer may contain Co as a main component, contain at least Pt, and further contain a metal oxide. The layer may contain one or more elements selected from B, Ta, Mo, Cu, Nd, W, Nb, Sm, Tb, and Ru, in addition to Pt and Co. If the layer contains the elements, the microparticulation of the magnetic particles can be facilitated, and the crystallinity and orientation can be improved. Accordingly, recording/reproduction characteristics for high recording density and thermal fluctuation characteristics can be obtained. Specifically, a CoPt-based alloy, a CoCr-based alloy, a CoCrPt-based alloy; and CoPtO, CoPtCrO, CoPtSi, CoPtCrSi, and CoCrSiO₂ alloys may be used for the perpendicular magnetic recording layer.

The thickness of the perpendicular magnetic recording layer may be set to 1.0 nm or more in order to measure a reproduced output signal with high accuracy. The thickness may be set to 40 nm or less in order to suppress intensity distortion of the signal. If the thickness is smaller than 1.0 nm, there is a tendency that a reproduced output is low and a noise component is dominant. On the other hand, when the thickness is larger than 40 nm, there is a tendency that the reproduced output becomes excessive and distortion in signal waveforms occurs.

A protective layer may be formed on the upper portion of the perpendicular magnetic recording layer. The protective layer is effective in preventing the corrosion and deterioration of the perpendicular magnetic recording layer and preventing damages on the surface of the medium when the magnetic recording head is in contact with the recording medium. Examples of protective layer materials include materials including C, Pd, SiO₂, and ZrO₂. Carbon may be classified into sp²-bonded carbon (graphite) and sp³-bonded carbon (diamond). Though sp³-bonded carbon is superior in durability and corrosion resistance to graphite, it is inferior in surface smoothness to sp²-bonded carbon. Usually, carbon is deposited by sputtering using a graphite target. In this method, amorphous carbon in which sp²-bonded carbon and sp³-bonded carbon are mixed is formed. Carbon in which the ratio of sp³-bonded carbon is larger is called diamond-like carbon (DLC). DLC is superior in durability and corrosion resistance and also in surface smoothness and therefore it is utilized as the protective layer for the magnetic recording layer.

A lubricant layer may be further formed on the upper portion of the protective layer. Examples of lubricants used for the lubricant layer include perfluoropolyether, fluoroalcohol, and fluorinated carboxylic acid. Thus, a perpendicular magnetic recording medium is formed on the substrate.

Process of Forming Mask Layer

A mask layer for transferring a concave-convex pattern is formed on a magnetic recording layer.

When the protective layer is formed on the magnetic recording layer, the mask layer can be formed on the protective layer.

The mask layer becomes a main mask in the processing of the magnetic recording layer. Thus, a material to maintain the etching selectivity between the magnetic recording layer and the metal fine particle material as described below may be used. As a specific material, a material which is selected from the group consisting of Al, C, Si, Ti, V, Cr, Mn, Co, Ni, Cu, Fe, Zn, Ga, Zr, Nb, Mo, Ru, Pd, Ag, Au, Hf, Ta, W, Pt, and is comprised of compounds or alloys thereof may be applied for the mask layer. Here, the compound is selected from oxides, nitrides, borides, and carbides. The alloy is comprised of two or more materials selected from the above groups. In this case, the mask layer material which can ensure the etching selectivity between the material of the metal fine particle film formed on the mask layer and the size of the concave-convex pattern is selected. Further, the film thickness can be appropriately determined.

These mask layers may be formed by vacuum deposition, electron-beam vacuum deposition, molecular-beam-deposition, ion-beam-deposition, ion plating, physical vapor deposition (PVD), chemical vapor deposition (CVD) using heat, light, and plasma, represented by spattering.

In the physical and chemical vapor deposition, the thickness of the mask layer can be adjusted by appropriately changing parameters such as the process gas pressure, the gas mass flow, the substrate temperature, the power supply, the ultimate vacuum, the chamber atmosphere, and the film formation time. The arrangement accuracy of the metal fine particle layer formed at the upper portion of the mask layer and the transfer accuracy of the concave-convex pattern strongly depend on the surface roughness of the mask layer. Therefore, it is possible to previously reduce the surface roughness of the mask layer. This is achieved by variously adjusting the film formation conditions. In order to pattern a narrow pitch with high resolution, the cycle of surface roughness based on a desired pattern pitch is made shorter. The average surface roughness may be set to 0.6 nm or less. This is because if the roughness is higher than 0.6 nm, the accuracy of arrangement of metal fine particles described below is worsened and the S/N signal from the magnetic recording medium is deteriorated.

It is possible to realize the reduction in the surface roughness by variously changing the film formation conditions and changing the material of the mask layer from a crystalline material to an amorphous material.

The thickness of the mask layer can be determined, taking into consideration the etching selectivity between the release layer and the magnetic recording layer and the size of the concave-convex pattern. When the mask layer is formed, the adjustment is achieved by changing parameters such as the process gas pressure, the gas mass flow, the substrate temperature, the power supply, the ultimate vacuum, the chamber atmosphere, and the film formation time. As the sputtering gas used for the film formation, a rare gas including Ar may be mainly used. According to the mask material for forming the film, reactive gases such as O₂ and N₂ may be mixed to form a desired alloy film.

The thickness of the mask layer may be set to a range of 1 nm to 50 nm to transfer a fine pattern with high resolution. If the thickness is smaller than 1 nm, the mask layer is not uniformly formed, while if the thickness is larger than 50 nm, the transfer accuracy of the concave-convex pattern in a depth direction tends to deteriorate.

As described below, the concave-convex pattern is formed on the magnetic recording layer through the mask layer and then the mask layer is removed so that a magnetic recording layer having a convexo-concave pattern can be produced. Here, when the mask layer is removed, the method such as dry etching or wet etching is used. The release layer is previously formed between the mask layer and the magnetic recording layer and then the layer is removed so that the mask layer can be peeled off from the top of the magnetic recording layer. When the protective layer is formed on the magnetic recording layer, the release layer can be formed on the protective layer.

The release layer is peeled off by dry etching or wet etching. Eventually, the layer plays a role in removing the mask material from the top of the magnetic recording layer.

The material of the release layer may be selected from various inorganic materials and polymer materials. Any etching solution which can dissolve these materials may be appropriately selected.

Examples of inorganic materials to be used for the release layer include metals such as C, Mo, W, Zn, Co, Ge, Al, Cu, Au, Ag, Ni, Si, SiO₂, and Cr, compound, and alloys formed of two or more metals. These inorganic materials can be peeled off by dry etching using an etching gas such as O₂, CF₄, Cl2, H₂, N₂ or Ar.

Further, acids such as hydrochloric acid, phosphoric acid, nitric acid, boric acid, acetic acid, hydrofluoric acid, ammonium fluoride, perchloric acid, hydrobromic acid, carboxylic acid, sulfonic acid, and hydrogen peroxide water; or a sodium hydroxide solution, a potassium hydroxide solution, a calcium hydroxide solution, a barium hydroxide solution, a magnesium hydroxide solution, an ammonium hydroxide solution, and alkali solutions such as tetramethylammonium hydroxide, tetrapropylammonium hydroxide, and phenyl trimethylammonium hydroxide may be used for each of the materials.

A buffer solution for adjusting the pH of each solution may be appropriately added.

Polymer materials are also used for the release layer. Examples thereof include novolak resin represented by a general-purpose resist material, polystyrene, polymethylmethacrylate, methylstyrene, polyethylene terephthalate, poly hydroxystyrene, polyvinyl pyrrolidone, and polymethyl cellulose. These resist materials can be peeled off using an organic solvent or water. In order to improve the etching resistance, it is possible to use the polymer materials and composite materials containing metals.

When the release layer is dissolved by the wet etching using an acid, an alkali, and an organic solvent, it is possible to make the solubility rate of the magnetic recording layer and the substrate sufficiently lower than the solubility rate of the release layer.

One or two layers of the mask layer can be formed. The magnetic recording layer and the mask layer on the release layer can be formed into, for example, a laminate including a first mask layer and a second mask layer. For example, the first mask layer and the second mask layer are formed of different materials so that the etching selectivity can be increased and the transfer accuracy can be improved. For convenience sake, the second mask layer is referred to as “transfer layer to the first mask layer. The magnetic recording layer, the mask layer, and the transfer layer are shown in this order from the substrate side.

The material of the transfer layer may be appropriately selected from various materials, taking into consideration the etching selectivity between the metal fine particle material and the mask layer material. When the combination of the mask material is determined, an etching solution or a metal material corresponding to the etching gas may be selected. When the dry etching is assumed and each material is combined, examples of the combination include C/Si, Si/Al, Si/Ni, Si/Cu, Si/Mo, Si/MoSi₂, Si/Ta, Si/Cr, Si/W, Si/Ti, Si/Ru, and Si/Hf in the order of the mask layer and the transfer layer from the substrate side. The configuration in which Si is replaced with SiO₂, Si₃N₄, SiC or the like may be used. Further, laminates such as Al/Ni, Al/Ti, Al/TiO₂, Al/TiN, Cr/Al₂O₃, Cr/Ni, Cr/MoSi₂, Cr/W, GaN/Ni, GaN/NiTa, GaN/NiV, Ta/Ni, Ta/Cu, Ta/Al, and Ta/Cr may be selected. Depending on the etching gas to be used in the mask processing, the stacking sequence of the various mask materials may be replaced.

The combination of the mask material and the stacking sequence are not limited thereto. From the viewpoint of the pattern size and the etching selectivity, they may be appropriately selected. Patterning can be performed by dry etching and wet etching. Thus, taking into consideration this, each mask material may be selected.

When the mask layer is patterned by wet etching, the side etch in the width direction of the concave-convex pattern is suppressed. This is achieved by setting various parameters such as the composition of the mask material, the concentration, the temperature, and the etching time of the etching solution.

Process of Forming Metal Fine Particle Layer

Then, a metal fine particle layer used as the concave-convex pattern is formed on the mask layer. Batch patterning in a large area is achieved by using the metal fine particle material. The process time can be greatly reduced as compared with the conventional methods for forming a convexo-concave pattern which include electron beam exposure. Further, when this is applied to the nanoimprinting process as described below, patterning in a large area can be performed at low cost.

Here, the process of forming a convexo-concave mask of metal fine particles includes (1) metal fine particles arrange on a substrate, (2) forming a overcoat layer which physically adheres the metal fine particles, and (3) irradiating with energy beams to deactivate the protective coating of the fine particles.

When the metal fine particles are used as the convexo-concave mask, a single layer of the metal fine particles can be arranged in a large area on the substrate. This allows variations at the location of the signal intensity in the magnetic recording medium to be decreased. Additionally, excellent glide characteristics are obtained, with the reduction in abnormal projections after the pattern transfer.

When the metal fine particles used as the convexo-concave mask are arranged on the substrate, a coating liquid containing metal fine particles dispersed in a solvent, i.e., a so-called dispersion is used. Hereafter, it is referred to as “coating liquid”. The coating liquid is a liquid in which at least one or more kinds of metal fine particles are monodispersed while the particles are located at regular intervals. The term “monodispersed” used herein means a state where the metal fine particles are not aggregated and attached to one another and they are independently present in the solution.

In order to stably disperse the metal fine particles in the solvent, the metal fine particle surface may be coated with the protective coating. The protective coating is defined to contain a surfactant and cover the metal fine particle surface. As the protective coating, one having a high affinity for the metal fine particle material may be used.

The protective coating may be applied before dispersing metal fine particles refined by various methods in a dispersion medium. Depending on the production process, a method for adding the fine particles to the dispersion medium so as to redisperse the particles may be used.

The protective coating plays a role in suppressing the aggregation of metal fine particles due to a chemical effect of reducing the van der waals attraction between the metal fine particles as well as a physical effect caused by steric hindrance of polymer chains.

Examples of protective groups contained in the protective coating include a thiol group, an amino group, a ketone group, a carboxyl group, an ether group, and a hydroxyl group.

Specific examples of the protective coating include alkanethiol, dodecanethiol, polyvinyl pyrrolidone, and oleylamine. Other examples of the protective coating include polymeric materials such as sodium polycarboxylate and ammonium polycarboxylate.

As the metal fine particle material, a material formed of at least one kind selected from the group of C, Pt, Ni, Pd, Co, Al, Ti, Ce, Si, Fe, Au, Ag, Cu, Ta, Zr, Zn, Mo, W, and Ru, and alloys, mixtures, and oxides of two or more kinds selected from the above group may be used.

Regarding the size of the metal fine particles, metal fine particles having an average particle diameter of 2 to 50 nm may be used. This is because if the average particle diameter of the fine particles is smaller than 2 nm. The production becomes more difficult, if the average particle diameter is larger than 50 nm, the peeling of a fine particle mask having a multilayer structure is insufficient and the surface smoothness is impaired.

The solvent for dispersing the metal fine particles may be selected from various organic solvents. Specific examples thereof include toluene, xylene, hexane, heptane, octane, ethylene glycol monoethyl ether, ethylene glycol monomethyl ether, ethylene glycol monomethyl ether acetate, propylene glycol monomethyl ether acetate, ethylene glycol trimethyl ether, ethyl lactate, ethyl pyruvate, tetradecane, cyclohexanone, dimethylformamide, dimethylacetamide, tetrahydrofuran, anisole, diethylene glycol triethyl ether, ethanol, methanol, isopropanol, and water.

The metal fine particles and the solvents are mixed to obtain a metal fine particle coating liquid. When the aggregation of the fine particles occurs, the metal fine particles can be dispersed by using a method such as ultrasonic dispersion after the mixing.

A dispersant for facilitating the monodispersion of the metal fine particles may be added to the metal fine particle coating liquid. The dispersant can be appropriately selected according to the combination of the protective coating and the solvent. For example, it can be selected from sodium polycarboxylate, polycarboxylic acid ammonium, amine polycarboxylate, poly alkylamine, and polyamine.

As binders, various polymer materials may be added to the metal fine particle coating liquid. Accordingly, the coating properties to the mask layer can be improved, and the adherence of the pattern to the underlayer can be enhanced.

The polymer materials used for the binders may be ones which are dissolved in the solvent of the coating liquid. Usable examples thereof include polystyrene, polymethylmethacrylate, polyvinyl alcohol, and polyvinyl pyrrolidone.

The metal fine particle coating liquid containing the metal fine particles mono-dispersed in these solvents is dropped and applied onto the mask layer. Examples of the method for coating the coating liquid includes various methods such as spin-coating, spray-coating, spin-casting, dip-coating, and ink-jetting. The amount of the coating liquid which is dropped onto the mask layer may be set to an amount which is enough to cover a desired coating area. When the metal fine particle layer is formed into a multilayer, the solution concentration, the solution viscosity, and the coating conditions may be variously adjusted. For example, in the spin-coating, the rotating speed of coating can be set to 10000 rpm or less to form a single layer structure in a large area. If the rotating speed is 10000 rpm or more, the defect area in the metal fine particles is expanded, and it tends to be difficult to form a single layer. When the metal fine particles are coated by spin-coating, the defect area in the metal fine particles can be reduced at intermediate and outer circumferences as compared with the inner circumference. Thus, the S/N signal shows an excellent value at intermediate and outer circumferences as compared with the inner circumference.

Further, when a pretreatment is performed on the surface of the mask layer, the affinity for the metal fine particle coating liquid can be increased and the coating properties of the metal fine particle coating liquid, (i.e., in-plane uniformity) can be improved. For example, a method for heating a substrate and applying a silane coupling agent may be used. Additionally, a method for forming a polymer material having a high affinity for a solvent on a mask layer may be used.

The adherence of the fine particles can be enhanced by performing a suitable post-treatment on the substrate coated with the metal fine particles. Specifically, a method comprising heating the substrate to remove the solvent in the coating liquid can be listed. In this case, it is possible to previously set the temperature to a temperature which does not thermally decompose the protective coating around the fine particles.

Process of Forming Overcoat Layer

Subsequently, an overcoat layer is formed on the metal fine particles. The overcoat layer is a thin film which covers the metal fine particle surface and the protective coating as described above.

The overcoat layer is a film which allows the metal fine particles arranged on the same flat surface to be uniformly adhered. When the protective coating and the lower layer of the mask layer are etched, the fine particles aggregate with the deactivation of the protective coating due to the plasma exposure or heating. On this subject, it is possible to suppress the aggregation due to the application of energy which is required for deactivation of protective groups by previously allowing the metal fine particles to be adhered to the overcoat layer. The material of the overcoat layer is formed in a gap between the protective coatings, and thus it is adhered to the metal fine particle surface. Thus, the layer has also an aggregation suppressing effect by decreasing the chemical activity of the metal fine particles.

The overcoat layer may be selected from various materials. For example, similarly to the above metal fine particle materials, the material may be selected from groups such as C, Pt, Ni, Pd, Co, Al, Ti, Ce, Si, Fe, Au, Ag, Cu, Ta, Zr, Zn, Mo, W, Ru, and Ge. Further, it may be selected from alloys of the groups and compounds such as oxides and nitrides.

The overcoat layer plays a role in deactivating protective groups by transmitting energy beams as described below. Thus, the thickness of the layer can be set to a thickness thinner than the thickness which shuts off the energy beams. In the production process, it can be set to 10 nm or less. When it is difficult to uniformly form the overcoat layer into a thin film, the layer is previously formed into a thick film and then the resulting film may be thinned by etching or the like.

Process of Deactivating Protective Coating

Subsequently, the protective coating of the metal fine particles is deactivated. Specifically, the polymer chains (protective coating) are cut by external irradiation with energy beams. Alternatively, the protective coating is subjected to a cross-linking reaction so as to suppress the aggregation between the metal fine particles.

If the metal fine particles lose the protective coating, with the irradiation with energy beams, the particles immediately aggregate when a gap between the adjacent fine particles is a free space. However, even if the protective coating is deactivated, the aggregation is suppressed because of physical adherence by the overcoat layer as described above. The gap between the protective coatings, namely, the overcoat layer formed on the metal fine particle surface decreases the chemical activity of the metal fine particles. Thus, the metal fine particles are in a state in which the aggregation is suppressed.

Energy beams can be selected from various beams. Usable examples thereof include ultraviolet rays, electron beams, and X-rays. When irradiating with energy beams, it may be performed in vacuum or in an inert gas atmosphere such as He or Ar. From the viewpoint of the tact time, ultraviolet rays may be used as the energy beams which can be simply emitted.

The energy which is irradiated with energy beams can be appropriately set according to various parameters such as wavelengths and applied voltages.

Process of Processing Overcoat Layer

A convexo-concave pattern formed of metal fine particles is formed on a mask by etching the overcoat layer and removing the layer.

As described above, the overcoat layer formed of various materials can be easily removed by selecting a suitable etching gas. As described below, each mask layer to be used as a lower layer is batch-processed to form the concave-convex pattern. For example, when C is used for the overcoat layer, the layer can be easily removed by dry etching with O₂. Additionally, in the case of materials such as Si and Ta, the overcoat layer can be removed by dry etching with CF₄. When only the overcoat layer can be appropriately removed without causing damages to the substrate, the magnetic recording layer, and the mask layer, the wet etching using a solution may be performed.

A series of processes including forming an overcoat layer, irradiating with energy beams, and processing the overcoat layer may be repeated two or more times. It may be performed until the aggregation of the metal fine particles is suppressed.

As described above, the metal fine particle layer having the independent pattern is obtained by removing the overcoat layer.

Process of Patterning Mask Layer

Subsequently, the metal fine particles as the concave-convex pattern are transferred to the mask layer.

In the processing of the mask layer, various layer configurations and processing methods can be achieved by the combination of the mask layer material and the etching gas.

When the fine processing is performed so that the etching in the thickness direction is more significant than the etching in the width direction of the concave-convex pattern, the dry etching can be used. Plasmas used for dry etching can be generated by various methods such as capacitive coupling, inductive coupling, electron cyclotron resonance, and multi-frequency superposition coupling. In order to adjust the size of the concave-convex pattern, parameters such as the process gas pressure, the gas mass flow, the plasma power supply, the bias power, the substrate temperature, the chamber atmosphere, and the ultimate vacuum can be set.

When the mask material is stacked to increase the etching selectivity, the etching gas may be appropriately selected. Examples of the etching gas include fluorine-based gases, such as CF₄, C₂F₆, C₃F₆, C₃F₈, C₅F₈, C₄F₈, ClF₃, CCl₃F₅, C₂ClF₅, CCBrF₃, CHF₃, NF₃, and CH₂F₂; and chlorine-based gases, such as Cl₂, BCl₃, CCl₄, and SiCl₄. In addition, various gases, such as H₂, N₂, O₂, Br₂, HBr, NH₃, CO, C₂H₄, helium, Ne, Ar, Kr, and Xe may be used. In order to adjust the etching rate and the etching selectivity, a mixed gas obtained by mixing two or more of these gases may be used. The patterning may be performed by wet etching. In this case, it is possible to select an etching solution which can ensure the etching selectivity and control the etching in the width direction. Similarly, a physical etching process like ion milling may be performed.

Similarly to the second embodiment, it possible that the metal fine particle pattern is transferred to the mask layer, and then the metal fine particles are removed from the mask layer. The clogging at the groove portion of the pattern due to the sub-products produced by etching and the aggregation of the fine particles can be reduced by previously removing the metal fine particles.

The dry etching can be used for the removal of the metal fine particles. Alternatively, the wet etching using a peeling solution corresponding to the metal fine particle material may be used. As for the peeling solution, one in which the mask layer being exposed, the magnetic recording layer, and the substrate material are hardly soluble is selected. For example, when Au is used for fine particles, the metal fine particle layer can be easily removed from the mask layer by wet etching using an etching solution comprised of a mixture of iodine/potassium iodide.

Taking into consideration the etching selectivity between the mask layer and the metal fine particle layer, the mask layer may have various configurations. As described above, it may be configured to include C/Si, Ta/Al, Al/Ni, and Si/Cr in this order from the substrate side.

When the interval between the metal fine particles is significantly narrow, the interval between the fine particles may be adjusted by intentionally etching the metal fine particle film. Specific examples of the etching method include a method for increasing the side etch in dry etching and a method for adjusting the incidence angle of the ions in ion milling and slimming metal fine particles in the width direction. As described above, a concave-convex pattern can be formed on a resist layer using a metal fine particle mask.

A nanoimprint stamper is produced through the process of applying the metal fine particles and the process of transferring the pattern to the mask layer, and the concave-convex pattern can be transferred to the magnetic recording layer by nanoimprint lithography.

The method for producing a stamper according to the embodiment includes forming a metal fine particle layer formed of metal fine particles coated with a protective coating on the mask layer; forming an overcoat layer on the metal fine particle layer; irradiating the metal fine particle layer with energy beams through the overcoat layer so as to deactivate the protective coating; forming a conductive layer having the concave-convex pattern on the concave-convex pattern formed of the metal fine particle film; forming an electroformed layer using the conductive layer as an electrode; and peeling off the conductive layer to form a stamper formed of the electroformed layer to which the concave-convex pattern is transferred.

The method for producing a magnetic recording medium according to the embodiment includes forming a metal fine particle layer formed of metal fine particles coated with a protective coating on the mask layer; forming an overcoat layer on the surface of the metal fine particle layer; irradiating the metal fine particle layer with energy beams through the overcoat layer so as to deactivate the protective coating; forming a conductive layer having the concave-convex pattern on the concave-convex pattern formed of the metal fine particle film; forming an electroformed layer using the conductive layer as an electrode; peeling off the conductive layer to form a stamper formed of the electroformed layer to which the concave-convex pattern is transferred; forming a magnetic recording layer on the substrate, forming a mask layer on the magnetic recording layer; forming an imprint resist layer on the mask layer; transferring the concave-convex pattern to the imprint resist layer using the stamper; transferring the concave-convex pattern to the mask layer; transferring the concave-convex pattern to the magnetic recording layer; and removing the mask layer from the magnetic recording layer.

The nanoimprint lithography is a process including pressing a nanoimprint stamper having a fine concave-convex pattern formed on its surface (hereafter referred to as “stamper”) against a resist layer for transferring to transfer the pattern. In the process, a resist pattern can be batch-transferred to a large area of the sample in a shorter time as compared with techniques such as step and repeat mode of ultraviolet ray exposure and electron beam exposure. Therefore, the production throughput is increased, and thus it is possible to achieve a decrease in the production time and a reduction in cost.

The stamper can be obtained from a substrate comprising a fine concave-convex pattern, i.e., a so-called master disc (a mold or a master). In many cases, the stamper is produced by subjecting the fine pattern of the master disc to electroforming. As the substrate for the master disc, a semiconductor substrate doped with impurities such as Si, SiO₂, SiC, SiOC, Si₃N₄, C, B, Ga, In, and P may be used. Additionally, a substrate formed of a material having conductivity may be used. Further, the shape of the substrate is not limited to the three-dimensional shapes, and it may be circular, rectangular or toroidal.

As for the pattern of the master disc, the metal fine particles may be used as the concave-convex pattern as described above. The pattern obtained by transferring the metal fine particle pattern to the mask layer may be used as a pattern for electroforming. Further, the concave-convex pattern is transferred to the master disc and the resulting pattern may be used as the pattern for electroforming.

Subsequently, the concave-convex pattern of the master disc is subjected to electroforming to form a stamper. Examples of electroformed, i.e., plated-metal include various materials. Here, as an example, a method for producing a stamper formed of Ni will be described.

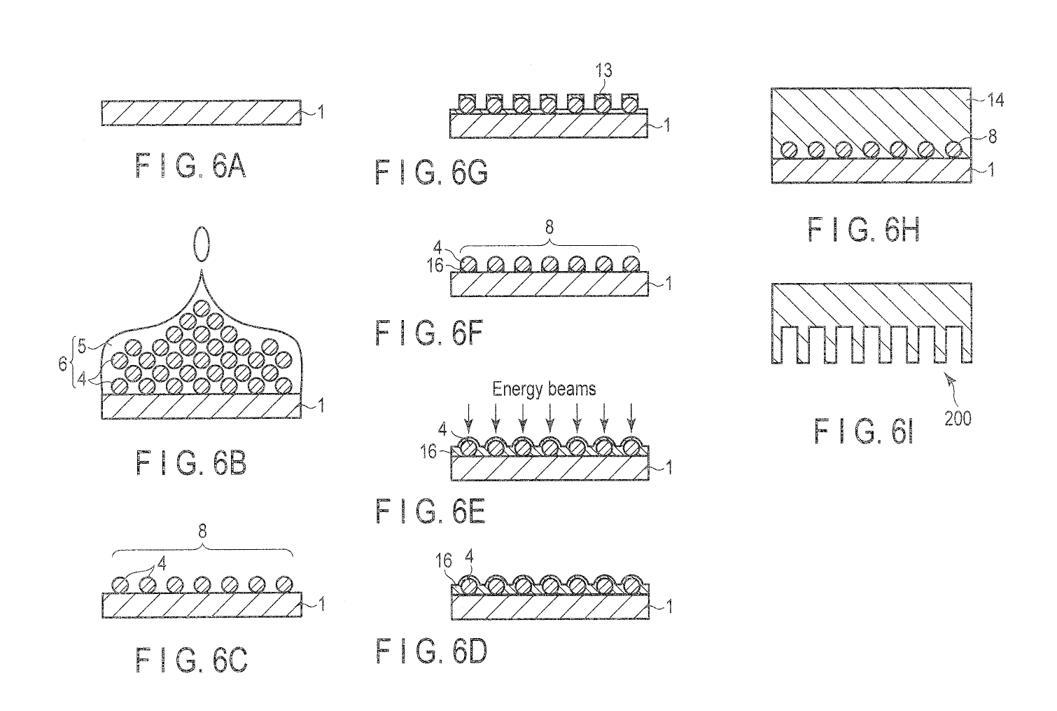

FIG. 6 shows the production process of the nanoimprint stamper.

As shown in FIG. 6A, a substrate 1 is prepared.

Then, as shown in FIG. 6B, a metal fine particle coating liquid 6 which includes metal fine particles 4 coated with protective coatings (not shown) and a solvent 5 is dropped and applied onto a mask layer 3 to obtain a metal fine particle film 8 having metal fine particles regularly arranged as shown in FIG. 6C.

Subsequently, as shown in FIG. 6D, an overcoat layer 16 which covers the surface of the metal fine particle film 8 and the surface of the substrate 1 having the metal fine particle film 8 formed thereon is formed.

Thereafter, as shown in FIG. 6E, the protective coatings on the surfaces of the metal fine particles 4 are deactivated by irradiating the metal fine particle film 8 with energy beams through the overcoat layer 16.

As shown in FIG. 6F, a master disk having a concave-convex pattern formed of the metal fine particle film 8 is formed on the surface of the mask layer 3 by etching the overcoat layer 16 using the metal fine particle layer 8 as the mask.

Subsequently, as shown in FIG. 6G, in order to give the conductivity to the concave-convex pattern of the master disc, a conductive film 13 is formed on the surface of the metal fine particle film 8 having a single layer structure. In the electroforming process as described below, if poor electric conduction is caused, the plating growth is inhibited, thereby leading to pattern defects. Accordingly, the conductive film 13 is uniformly formed on the surface of the concave-convex pattern and the side surface. However, when a conductive material is used for the metal fine particles and the substrate, it is not limited thereto. The concave-convex pattern can have electrical continuity. In this case, the conductive film 13 may be formed on the top portion and side surface of a metal fine particle and gaps between the particles.

The conductive film 13 may be selected from various materials. Examples of the materials of the conductive film 13 include Ni, Al, Ti, C, Au, Ag, Cr, and Cu. Here, examples using Ni will be explained.

The conductive film 13 formed on the metal fine particle may be integrated with the metal fine particle pattern.

Subsequently, as shown in FIG. 6H, the master disc is immersed in a sulfamic-acid Ni or NiP bath and energized, followed by electroforming to form an electroformed layer 14 as a stamper on the conductive film 13.

A stamper 200 thus obtained is released from the substrate 1 as shown in FIG. 6I.

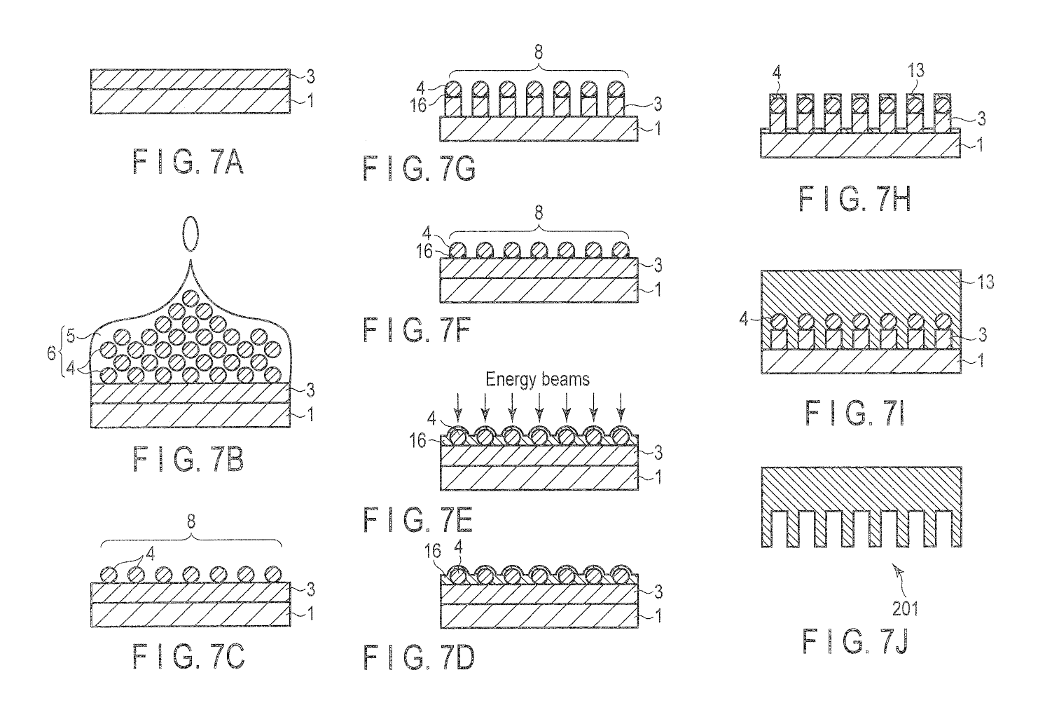

FIG. 7A to 7J show a modification of the production process of the nanoimprint stamper. This embodiment is almost the same as the production process of the stamper shown in FIGS. 6A to 6I except that the process of forming the mask layer 3 on the substrate 1 is included.

As shown in FIG. 7A, a mask layer 3 is formed on a substrate 1.

As shown in FIG. 7B, the metal fine particle coating liquid is dropped onto the mask layer 3.

As shown in FIG. 7C, a metal fine particle film 8 having metal fine particles regularly arranged on the mask layer 3 is formed.

As shown in FIG. 7D, an overcoat layer 16 which covers the surface of the metal fine particle film 8 and the surface of the mask layer 3 having the metal fine particle film 8 formed thereon is formed.

Thereafter, as shown in FIG. 7E, the protective coatings on the surfaces of the metal fine particles 4 are deactivated by irradiating the metal fine particle film 8 with energy beams through the overcoat layer 16.

As shown in FIG. 7F, the overcoat layer 16 is etched using the metal fine particle layer 8 as a mask.

As shown in FIG. 7G, a concave-convex pattern of a single layer of the metal fine particle film 8 is transferred to the mask layer 3 to obtain a master disc having the concave-convex pattern formed of the metal fine particle film 8 on the surface of the mask layer 3.

Subsequently, as shown in FIG. 7H, in order to apply conductivity to the concave-convex pattern of the master disc, the conductive film 13 is formed on the surface of the metal fine particle film 8 having a single layer structure.

Subsequently, as shown in FIG. 7I, the master disc is immersed in a sulfamic-acid Ni or NiP bath and energized, followed by electroforming to form an electroformed layer 14 as a stamper on the conductive film 13.

A stamper 200 thus obtained is released from the substrate 1 as shown in FIG. 7J.

After the process of FIG. 7G, the concave-convex pattern is transferred to the substrate 1 through the mask layer 3. A master disc having a substrate (not shown) to which the convexo-concave pattern is transferred is used to produce a stamper.

The stamper is used as an alternative to the master disc so that a duplicated stamper can be produced. In this case, examples of the production method include a method for producing a Ni stamper from a Ni stamper, a method for producing a resin stamper from a Ni stamper or the like. Here, a method for producing a resin stamper which is relatively cost-effective and easy to produce will be described.

The resin stamper is produced by injection molding. First, the Ni stamper is loaded in an injection molding machine. A resin solution material is flowed onto the concave-convex pattern of the stamper, followed by injection molding. As the resin solution material, a cycloolefin polymer, polycarbonate, polymethylmethacrylate or the like may be used. Further, a material having good peel properties with respect to the imprint resist as described below may be selected. After the injection molding, the sample is peeled off from the top of the Ni stamper to obtain a resin stamper having a concave-convex pattern.

The obtained resin stamper is used to transfer the concave-convex pattern. As described above, a sample in which the magnetic recording layer and the mask layer are formed in this order from the substrate side is used and further the imprint resist layer is formed on the mask layer. The resultant product is used as the sample. Various resist materials such as heat-curing and photo-curing resins may be used for the imprint resist. For example, isobornyl acrylate, allyl methacrylate, and dipropylene glycol diacrylate may be used.

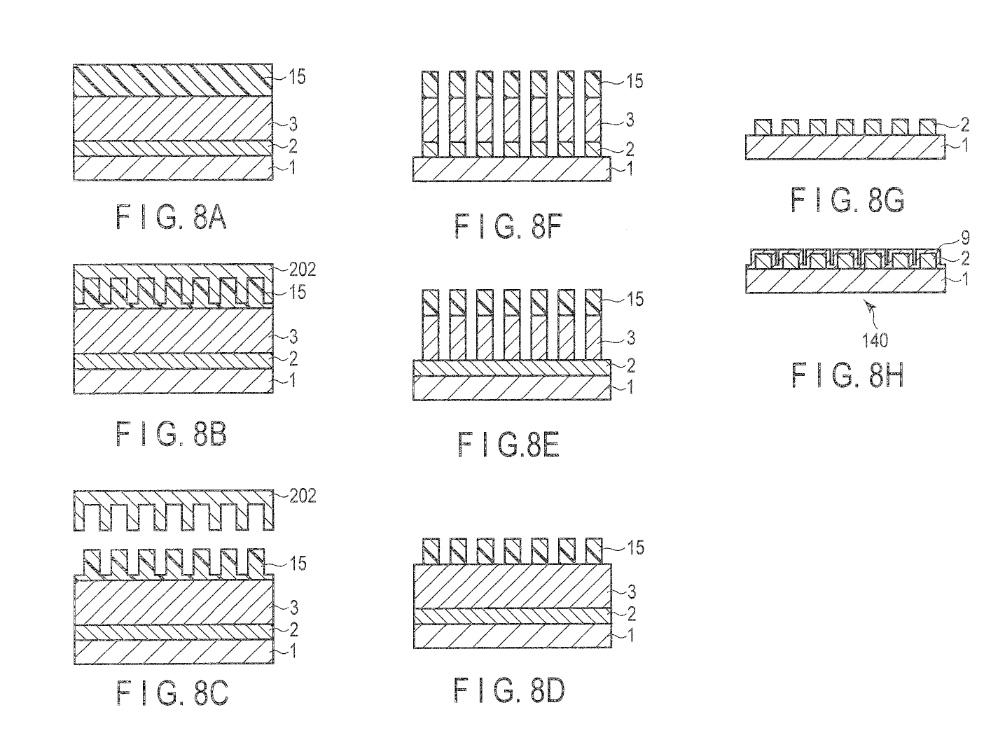

FIGS. 8A to 8H show views for explaining another example of the method for producing a magnetic recording medium according to the first embodiment.

As shown in FIG. 8A, these resist materials are applied to the sample having the magnetic recording layer 2 and the mask layer 3 on the substrate 1 to form a resist layer 15. Subsequently, as shown in FIG. 8B, a resin stamper 202 having a concave-convex pattern is imprinted on the resist layer 15. If the resin stamper 202 is pressed against the resist in the imprinting process, the resist is fluidized to form a concave-convex pattern. Here, if energies such as ultraviolet rays are applied to the resist layer 15 to cure the resist layer 15 having the concave-convex pattern thereon and then the resin stamper 202 is released, the concave-convex pattern of the resist layer 15 is obtained. In order to easily release the resin stamper 202, the surface of the resin stamper 202 may be subjected to a releasing treatment using a silane coupling agent.

Subsequently, as shown in FIG. 8C, the resin stamper 202 to which an imprint resist is pressed is released. After the release of the resin stamper 202, the resist material remains as a residue in a recess portion of the resist layer 15. Thus, as shown in FIG. 8D, the surface of the mask layer 3 is exposed by removing the material by etching. Since the polymer-based resist material has generally low etching resistance to the O₂ etchant, the residue can be easily removed by dry etching using an O₂ gas. When an inorganic material is included, the etching gas can be appropriately changed so as to allow the resist pattern to remain. As shown in FIGS. 8D, 8F, 8G, and 8H, the concave-convex pattern is transferred to the mask layer 3 and the magnetic recording layer 2, and then a magnetic recording medium 140 having a concave-convex pattern can be produced by nanoimprint lithography through the process of forming the protective film 9.

Process of Patterning Magnetic Recording Layer

Following the process of patterning the mask layer, the concave-convex pattern is transferred to the magnetic recording layer at the lower portion of an alloy release layer.

Examples of a typical method for forming isolated magnetic dots include the reactive ion etching and milling methods. Specifically, the patterning can be performed by the reactive ion etching method using CO or NH₃ as an etching gas or by the ion milling method using an inert gas such as He, Ne, Ar, Xe or Kr.

In the process of patterning the magnetic recording layer, a relation between the etching rate of the mask layer (ERₘₐₛₖ) and the etching rate of the magnetic recording layer (ER_{mag}) satisfies a relation: ERₘₐₛₖ≦ER_{mag}. That is, in order to obtain a desired thickness of the magnetic recording layer, the regression of the mask layer caused by etching can be smaller.

When the convexo-concave is transferred to the magnetic recording layer by ion milling, it is necessary to reduce by-products scattering to the mask side surface (so-called redeposition components). The redeposition components are adhered to the periphery of the convex pattern mask, and thus the size of the convex pattern is expanded and the groove portion is buried. Accordingly, in order to obtain a divided magnetic recording layer pattern, the redeposition components are reduced as much as possible. If the deposition components generated at the time of etching of the magnetic recording layer at the lower portion of the release layer cover the side surface of the release layer, the release layer is not exposed to the peeling solution. As a result, the peel properties are deteriorated. Consequently, after all, the redeposition components are reduced as much as possible.

When the magnetic recording layer is subjected to the ion milling method, the redeposition components scattering to the side surface can be reduced by changing the incidence angle of ions. In this case, although an optimal incidence angle varies depending on the mask height, the redeposition components can be reduced by changing the angle in a range of 20° to 70°. The incidence angle of ions may be appropriately changed during milling. For example, a method including milling processing a magnetic recording layer at an ion incident angle of 0°, changing the ion incident angle, and selectively removing the redeposition part of the convex pattern is used.

Process of Removing and Peeling Off Mask Layer

Subsequently, the mask pattern on the magnetic recording layer is removed to obtain a magnetic recording layer having a concave-convex pattern.

When peeling is performed by dry etching, chemical reformulation of the surface of the magnetic recording layer can be reduced. Further, etching can be performed so as not to reduce the thickness of the magnetic recording layer.

When the release layer is dissolved by wet etching, it is possible to allow the solubility rate for the magnetic recording layer and the substrate to be lower than that for the release layer.

When the dry etching is chemically performed using an active gas, the surface is exposed to an activated gas so as to be reformed again. This achieves improvement in the peel properties. For example, when the surface of the release layer is oxidized due to excessive exposure to oxygen plasma, the reduction reaction is facilitated by re-exposure to hydrogen plasma. Thus, the peel properties of the release layer can be maintained. The side surface of the release layer may be reformed by washing with a solution. For example, a fluorine compound is removed by washing the fluorine compound attached to the side surface of the release layer with water after exposure to fluorine plasma so that the surface of the release layer can be cleaned.

In the fourth embodiment, the release layer formed on the magnetic recording layer is removed so that the mask layer can be peeled off from the magnetic recording layer. In this case, the layer may be peeled by wet etching in addition to dry etching.

Process of Forming Protective Layer

Finally, a carbon-based protective layer and the fluorine-based lubricating film (not shown) are formed on the magnetic recording layer having a convexo-concave pattern so that a magnetic recording medium having the concave-convex pattern can be obtained.

A DLC film containing a large amount of sp³-bonded carbon may be used for the carbon protective layer. The film thickness may be set to 0.5 nm or more in order to maintain coatability. The film thickness may be set to 10 nm or less in order to maintain the S/N signal. Usable examples of lubricants include perfluoropolyether, fluoroalcohol, and fluorinated carboxylic acid.

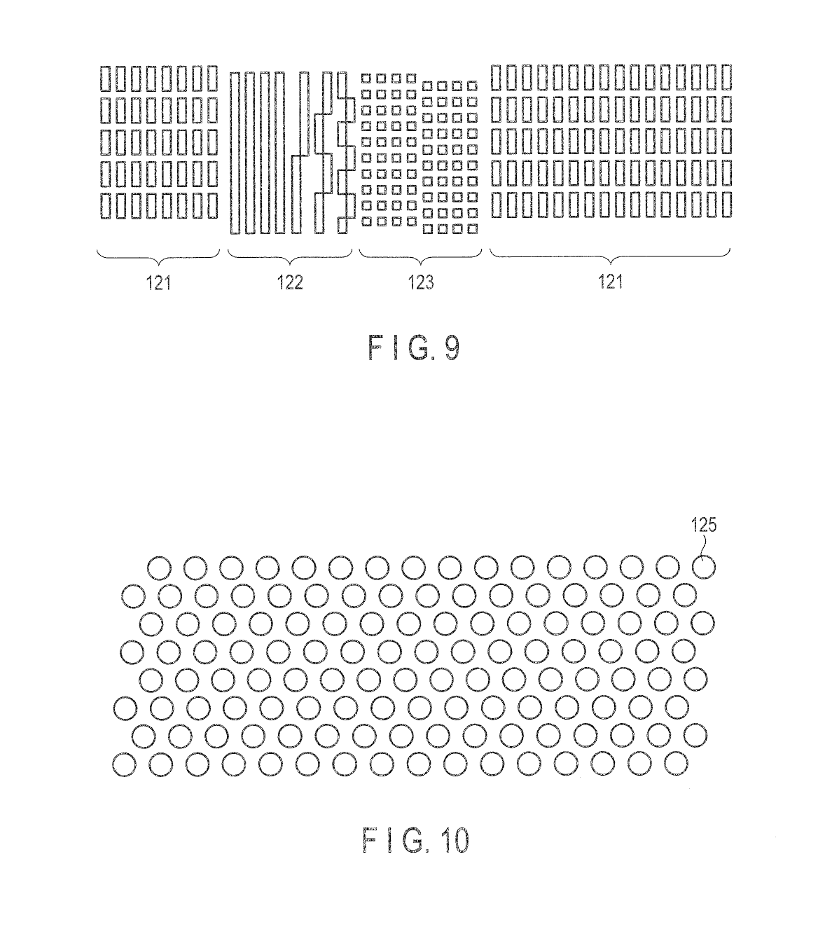

FIG. 9 shows a view showing an example of a record bit pattern in a circumferential direction of a magnetic recording medium.

As shown the drawing, the convex pattern of the magnetic recording layer is classified roughly into so-called servo areas 124: a record bit area 121 which records the data corresponding to digital signals “1” and “0”; a preamble address pattern 122 which is a signal to determine the location of a magnetic recording head; and a burst pattern 123. This pattern can be formed as an in-plane pattern. The shown pattern of the servo area may be a rectangular shape. For example, all the servo patterns may be replaced with dot shapes.

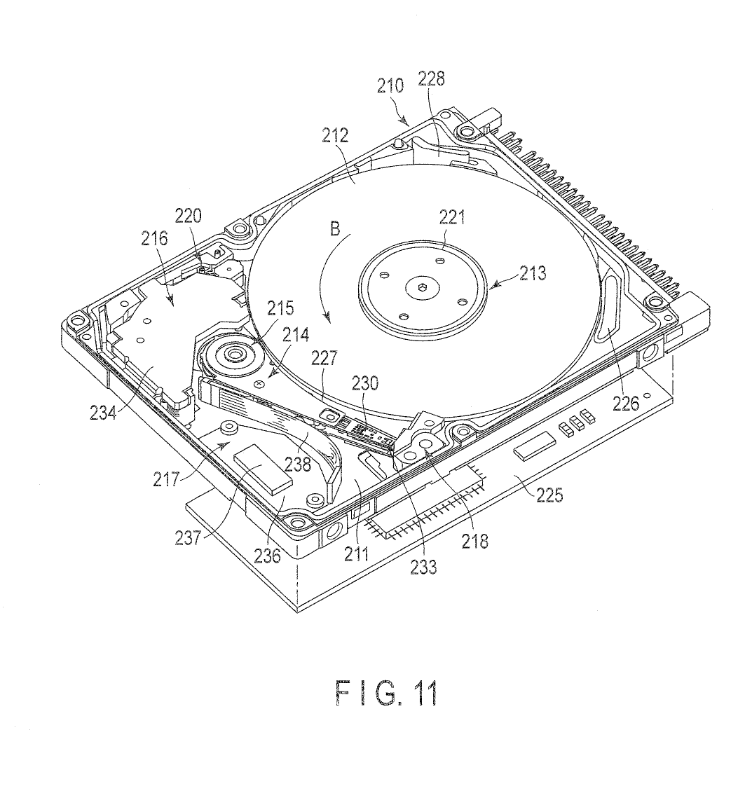

Like FIG. 10, the servo and the data area may be formed of dot patterns 125. 1-bit information may be configured to have a magnetic dot or a plurality of magnetic dots.

FIG. 11 is a partially disassembled perspective view of a magnetic recording/reproducing device to which the magnetic recording medium according to the embodiments can be applied.

The same drawing shows the internal structure in which the top cover of the hard disk drive according to the embodiment is detached as a disk device. As shown in the drawing, the HDD comprises a case 210. The case 210 comprises a rectangular box-shaped base 211 having an open upper surface and a rectangular plate-shaped top cover (not shown). The top cover is screwed to the base 211 with a plurality of screws and thereby closes the top opening of the base 211. As a result, the inside of the case 210 is kept air-tight and can exchange air with the outside only through a breathing filter 226.

A magnetic disk 212 (recording medium) and a driving unit are provided on the base 211. The driving unit comprises a spindle motor 213 which supports and rotates the magnetic disk 212, a plurality of (e.g., two) magnetic heads 233 which record and reproduce information on and from the magnetic disk 212, a head actuator 214 which supports the magnetic heads 233 in such a manner that they are movable with respect to the surfaces of the magnetic disk 212, and a voice coil motor (hereinafter referred to as “VCM”) 216 which rotates and positions the head actuator 14. A lamp loading mechanism 218 which holds, at a position that is spaced from the magnetic disk 212, the magnetic heads 233 when they have been moved to the outermost periphery of the magnetic disk 212, an inertia latch 220 which holds the head actuator 214 at an escape position when the HDD has received impact or the like, and a board unit 217 which is mounted with electronic components such as a preamplifier and a head IC are also provided on the base 211.

A control circuit board 225 is screwed to the external surface of the base 211 so as to be opposed to the bottom wall of the base 211. The control circuit board 225 controls operations of the spindle motor 213, the VCM 216, and the magnetic heads 233 via the board unit 217.

In FIG. 11, the magnetic disk 212 is configured as the perpendicular magnetic recording medium having the concave-convex pattern formed by the above processing method. The magnetic disk 212 has, for example, a substrate 219 which is formed into a disc shape having a diameter of about 2.5 inch and is comprised of a nonmagnetic material. A soft magnetic layer 223 as an underlayer is formed on each surface of the substrate 219 and a perpendicular magnetic recording layer 222 having magnetic anisotropy in a perpendicular direction to the disc surface is formed on the soft magnetic layer 223. Further, a protective film 224 is formed thereon.

The magnetic disk 212 is fitted with the hub of the spindle motor 213 concentrically, and is clamped by a clamp spring 221 screwed to the top end of the hub and is thereby fixed to the hub. The magnetic disk 212 is rotationally driven by the spindle motor 213 (drive motor) in the direction indicated by an arrow B at a predetermined speed.

The head actuator 214 comprises a bearing unit 215 which is fixed to the bottom wall of the base 211 and a plurality of arms 227 which extend from the bearing unit 215. The arms 227 are spaced from each other by a predetermined interval and extend in the same direction from the bearing unit 215 parallel with the surfaces of the magnetic disk 212. The head actuator 214 comprises suspensions 230 each of which is elastically deformable and is shaped like a long and narrow plate. Each suspension 30, which is a leaf spring, extends from the corresponding arm 227 with its base end portion spot-welded or bonded to the tip portion of the arm 227. A magnetic head 233 is supported by the extending end of each suspension 230 through a gimbal spring 241. Each suspension 230, the gimbal spring 241, and the magnetic head 233 constitutes a head gimbal assembly. The head actuator 214 may have a configuration comprising a so-called E block in which a sleeve of the bearing unit 215 is integrated with the arms.

The magnetic recording medium having the convexo-concave pattern formed thereon is used for the magnetic recording/reproducing device so that a drive having a high recording density and a high S/N signal can be obtained.

Hereinafter, examples will be shown, and the embodiments will be specifically described.

### Example 1

Example 1 is a process of forming a magnetic recording layer, a mask layer, and a metal fine particle layer on a substrate, and then transferring a concave-convex pattern to the magnetic recording layer. As described below, Examples 1 to 4 are examples in which the type of energy beams being emitted and the irradiation atmosphere are changed in order to remove and deactivate the protective coating of the periphery of the metal fine particle layer.

A 2.5 inch-diameter toroidal substrate was used as the substrate, and the magnetic recording layer was formed on the substrate by the DC sputtering method. Ar was used as the process gas, the gas pressure was set to 0.7 Pa, the gas mass flow was set to 35 sccm, and the power supply was set to 500 W. A 10-nm thick NiTa underlayer, a 4-nm thick Pd underlayer, a 20-nm thick Ru underlayer, and a 5-nm thick CoPt recording layer were formed in this order from the substrate side. Finally, a 3-nm thick Pd protective layer was formed to obtain a magnetic recording layer.

Then, the mask layer was formed on the Pd protective layer. Here, a three-layered mask was used to transfer the concave-convex pattern of the metal fine particle layer with high resolution. A 30-nm thick C layer as the first mask layer, a 5-nm thick Si layer as the transfer layer at the upper portion, and a 3-nm thick C layer as the third mask layer were formed in this order from the substrate side. In the formation of each mask layer, a facing-targets sputtering system was used and each film was formed by spattering under the conditions of Ar gas flow rate of 35 sccm, Ar gas pressure of 0.7 Pa, and power supply of 500 W.

Subsequently, a coating liquid for forming the metal fine particle mask was produced. As the coating liquid, one prepared from a mixture of a dispersion of metal fine particles and a high polymer binder was used.

As the metal fine particles, Au particles having an average particle diameter of 8 nm whose surfaces were coated with an alkanethiol group were used. Polystyrene having an average molecular weight of 2800 was used as the high polymer binder. The binder and the particles were mixed so as to have a weight ratio (Au:polystyrene) of 2:3. The resultant mixture was diluted at a concentration of 3.5 wt % with toluene as a solvent to prepare a solution. Finally, the metal fine particle solution was dispersed using an ultrasonic dispersion machine and the monodispersion of the fine particles was facilitated to produce a coating liquid. When the metal fine particles are monodispersed, the dispersant of fine particles, (i.e., a surfactant) may be added.

Subsequently, a metal particulate resist layer was formed on a C film. An appropriate amount of the produced metal fine particle coating liquid was dropped onto the C film, followed by spin coating at a rotating speed of 4500 rpm to form a metal fine particle layer on the substrate. Further, the substrate was baked to remove the dispersion medium from the metal fine particle layer, and thus the adherence with the substrate was enhanced. The baking process was performed using a hot plate. The temperature was 140° C. and the retention time was 5 minutes.

Subsequently, an overcoat layer was formed on the metal fine particle layer. When the overcoat layer is uniformly covered from the upper surface of the metal fine particle layer, the overcoat layer plays a role in allowing the fine particles to be adhered. The C film was used for the overcoat layer.

The C film was formed by the DC sputtering method under the conditions of gas pressure of 0.7 Pa, gas mass flow of 35 sccm, and power supply of 500 W so as to have a thickness of 3 nm from the metal fine particle surface.

Then, the top of the overcoat layer was irradiated with energy beams. When irradiated with energy beams, the energy beams which were transmitted through the overcoat layer were illuminated to the protective coating around the metal fine particles. Thus, the polymer chains forming the protective coating were cleaved and the activity of the metal fine particles was reduced. Additionally, the material of the overcoat layer was adhered to the surfaces of the metal fine particles so as to fill the protective coating gap. Thus, the aggregation after processing was hardly caused.

Here, ultraviolet rays were used as energy beams, and the irradiation with ultraviolet rays was performed in a vacuum atmosphere. In the irradiation process, a sample was placed in a vacuum vessel, and then the inside of the vessel was evacuated. When the degree of vacuum reached 10⁻² Pa, the vessel was irradiated with ultraviolet rays generated from a high-pressure mercury lamp for 30 seconds. Thereafter, venting of the vessel was performed with N₂ gas and the sample was recovered. The wavelength of ultraviolet rays to be irradiated was 365 nm. The value is not limited to this example and ultraviolet rays having various wavelengths may be emitted.

Subsequently, the overcoat layer at the upper portion of the metal fine particles was removed to obtain a metal fine particle layer having a separated concave/convex pattern. Here, dry etching using an O₂ etchant was performed on a C overcoat layer to remove the overcoat layer and the protective coating amount the metal fine particles. In the dry etching, an inductively coupled plasma dry etching device was used. The etching was performed under the conditions of pressure of 0.1 Pa, gas mass flow of 20 sccm, power supply of 40 W, and bias power of 40 W for 4 seconds to remove the overcoat layer.

Subsequently, the C film having a thickness of 3 nm at the lower portion of the metal fine particles was removed by dry etching using an O₂ etchant. In the dry etching, the inductively-coupled plasma etching was used. The etching was performed under the conditions of pressure of 0.1 Pa, gas mass flow of 20 sccm, power supply of 40 W, and bias power of 40 W for 5 seconds to transfer the pattern to the C mask. The time required for coating the metal fine particles and transferring the metal fine particle pattern, namely, a tact time is about 38 minutes. This example is an example in which the tact time can be greatly shortened as compared with the comparative examples described below. The production throughput can be improved.

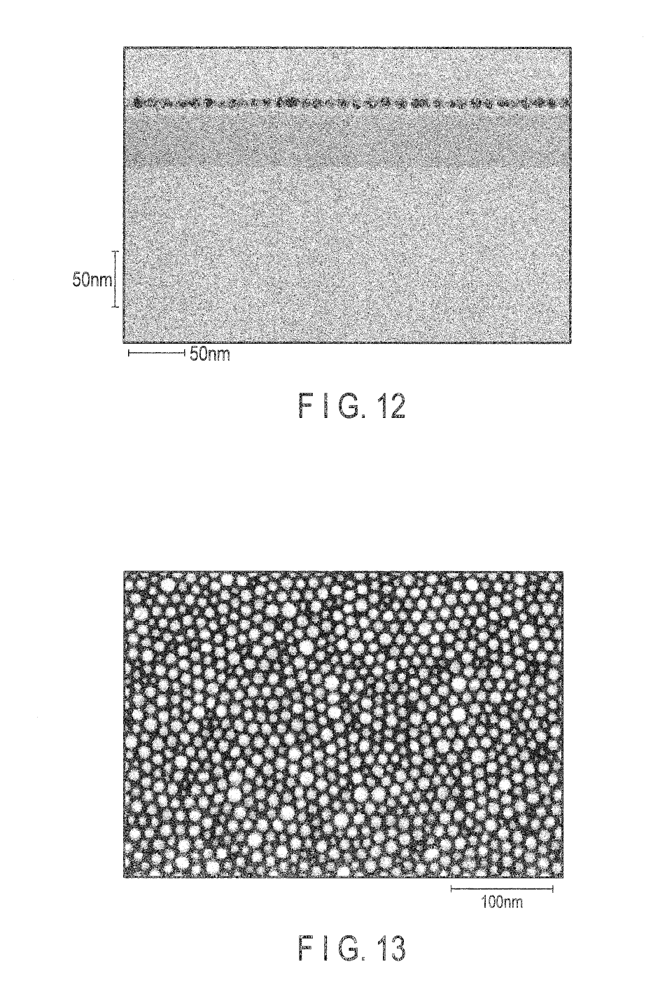

FIG. 12 shows a cross section TEM photograph after the processing of the C mask. It was found that even if the processing time was increased, the aggregation of Au particles was not formed and the concave/convex pattern was independently held on the substrate. An upper SEM image is shown in FIG. 13. It is found that the fine particle pattern is not extensively aggregated and the separability of the pattern is maintained.

After transfer of the concave/convex pattern to the C film, it is possible to transfer the pattern to the lower layer using the metal fine particles as a mask. In order to completely suppress the aggregation of the fine particles during processing, the fine particles may be removed from the substrate. Here, the metal fine particles were dissolved and removed after transfer of the concave/convex pattern to the C mask.

An aqueous solution comprised of iodine, potassium iodide, and ethyl alcohol was used to dissolve the Au particles. The solution was prepared at a weight ratio of 1:2:3. Subsequently, the sample was immersed in the mixed solution for 10 seconds, followed by washing with running water and ethyl alcohol for 60 seconds. Thus, the metal fine particle layer was dissolved and removed from the substrate.

In the following examples, unless otherwise noted, the process of removing the metal fine particles from the substrate after transfer of the concave-convex pattern at the lower portion of the metal fine particle layer is included.

Subsequently, the pattern was transferred to the lower-layer Si and the C mask. The pattern was transferred by the inductively-coupled plasma etching. In the process of transferring the concave-convex pattern to an Si film, etching using CF₄ gas as an etchant was performed under the conditions of gas pressure of 0.1 Pa, gas mass flow of 20 sccm, power supply of 100 W, and bias power of 30 W for 5 seconds.

The pattern was transferred to the lower-layer C mask. In the process of transferring the pattern to the C film, the concave-convex pattern was transferred to the mask layer by etching using an O₂ etchant under the conditions of gas pressure of 0.1 Pa, gas mass flow of 20 sccm, power supply of 40 W, and bias power of 40 W for 28 seconds.

Subsequently, the concave-convex pattern was transferred to the magnetic recording layer. Here, an Ar ion milling method was used. The concave-convex pattern was transferred to a 5 nm-thick CoPt recording layer and a 3 nm-thick Pd layer by milling under the conditions: Ar ion acceleration voltage; 300 V, gas mass flow of 3 sccm, process pressure: 0.1 Pa, and incidence angle of ions to the substrate: 90° (vertical incidence) for 65 seconds. Further, in order to remove the remained mask layer, the mask layer was removed from the top of the magnetic recording layer by milling under the conditions: Ar ion acceleration voltage; 100 V, gas mass flow of 3 sccm, process pressure: 0.1 Pa, and incidence angle of ions to the substrate: 90° (vertical incidence) for 5 seconds.

Finally, a 2-nm thick DLC film was formed. Thereafter, a perfluoro polyether-based lubricating film was formed so as to have a thickness of 1.5 nm and a magnetic recording medium having a concave-convex pattern was obtained.

The flying height of the head from the obtained magnetic recording medium was measured with a glide height tester and flying characteristics were evaluated. As a result, the measurement height exceeded a flying height of 10 nm which is the standard required to perform the read/write evaluation process.

Finally, the recording/reproduction characteristics of the media were evaluated by measuring the electromagnetic conversion characteristics by using a read/write analyzer RWA1632 and a spinstand S1701MP (manufactured by GUZIK, U.S.A.). The recording/reproduction characteristics were evaluated by using a head provided, at the writing portion thereof, with a shielded pole type magnetic pole which is a shield-attached single pole type magnetic pole (the shield acts to converge the magnetic flux to be emitted from a magnetic head) and also provided, at the reading portion thereof, with a TMR element, and measuring the signal-to-noise ratio (SNR) with the condition of recording frequency being set to 1200 kBPI in linear recording density. As a result, a value of 12.4 dB (as the SNR value of the medium) was obtained.

Further, as the pattern transfer layer, for example, an Si layer can be formed between the mask layer and the metal fine particle layer.

Si, which is a pattern transfer layer, can be formed by the DC sputtering method. For example, Ar is used as the process gas, the gas pressure is set to 0.7 Pa, the gas mass flow is set to 35 sccm, and the power supply is set to 500 W so that 3-nm thick Si can be formed. As a result, a four-layer mask containing of 30 nm-thick C, 5 nm-thick Si, 3 nm-thick C, and 3 nm-thick Si can be provided on the magnetic recording layer.

The Si transfer layer can be processed by dry etching. For example, an Si transfer layer having a thickness of 3 nm can be processed by etching under the conditions of etchant of CF₄, gas pressure of 0.1 Pa, gas mass flow of 20 sccm, power supply of 50 W, and bias power of 5 W for 9 seconds.

A magnetic recording medium having a concavo-convex shape can be produced by transferring the concave-convex pattern to the mask layer and the magnetic recording layer, similarly to Example 1. As for the thus obtained magnetic recording medium, an SNR value of the medium was 12.2 dB.

Examples 2 to 4 show an example in which energy beams with which a range from the top of the overcoat layer to the metal fine particles is irradiated are changed.

### Example 2

Example 2 was performed similarly to Example 1, except that the energy beams were ultraviolet and the irradiation atmosphere was N₂.

In order to prepare for the irradiation atmosphere of energy beams, a container carrying a sample was evacuated. When the ultimate pressure reached 10⁻² Pa, the N₂ gas was introduced into the container to allow the container to be purged. Further, the evacuation and the N₂ gas purge were repeated twice to convert the inside of the container to an N₂ atmosphere.

Thereafter, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.5 dB (as the SNR value of the medium) was obtained.

### Example 3

Example 3 was performed similarly to Example 1, except that the energy beams were ultraviolet and the irradiation atmosphere was Ar.

In order to prepare for the irradiation atmosphere of energy beams, a container carrying a sample was evacuated. When the ultimate pressure reached 10⁻² Pa, the Ar gas was introduced into the container to allow the container to be purged. Further, the evacuation and the Ar gas purge were repeated twice to convert the inside of the container to an Ar atmosphere.

Thereafter, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.7 dB (as the SNR value of the medium) was obtained.

### Example 4

Example 4 was performed similarly to Example 1 except that energy beams were electron beams.

A one-shot surface electron beam exposure system was used for irradiation with energy beams. The ultimate pressure was set to 3×10⁻⁶ Pa, and the accelerating voltage was set to 5 kV. The irradiation with electron rays was performed for 10 seconds.

Thereafter, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12 dB (as the SNR value of the medium) was obtained.

Hereinafter, examples in which metal fine particles are variously changed and used will be shown in Examples 5 to 23.

### Example 5

Example 5 was performed similarly to Example 5 except that the Si transfer layer was included between the metal fine particle layer and the mask layer.

The Si transfer layer was formed by the DC sputtering method. The ultimate pressure was set to 0.7 Pa and the power supply was set to 500 W, and Si with a thickness of 3 nm was used to form the transfer layer.

Since the overcoat layer of the upper portion of the metal fine particle layer was made of C, the irradiation with energy beams was performed, followed by the removal of the overcoat layer by dry etching using an O₂ etchant. The inductively coupled plasma etching was used for the dry etching. The etching was performed under the conditions of O₂ gas pressure of 0.1 Pa, gas mass flow of 20 sccm, power supply of 40 W, and bias power of 40 W for 8 seconds to remove the overcoat layer.

Subsequently, CF₄ etching was performed to transfer the metal fine particle pattern to the Si transfer layer. The CF₄ etching was performed by the inductively coupled plasma etching, similarly to the O₂ etching. The etching was performed under the conditions of gas pressure of 0.1 Pa, gas mass flow of 20 sccm, power supply of 100 W, and bias power of 30 W for 7 seconds to transfer the concave-convex pattern to the Si transfer layer.

Thereafter, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.1 dB (as the SNR value of the medium) was obtained.

### Example 6

Example 6 was performed similarly to Example 5, except that C fine particles having an average particle diameter of 8.2 nm were used.

C fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.3 dB (as the SNR value of the medium) was obtained.

### Example 7

Example 7 was performed similarly to Example 5, except that AI fine particles having an average particle diameter of 15.3 nm were used.

AI fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.2 dB (as the SNR value of the medium) was obtained.

### Example 8

Example 8 was performed similarly to Example 5, except that Si fine particles having an average particle diameter of 19.8 nm were used.

Si fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.4 dB (as the SNR value of the medium) was obtained.

### Example 9

Example 9 was performed similarly to Example 5, except that Ti fine particles having an average particle diameter of 19.3 nm were used.

Ti fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12 dB (as the SNR value of the medium) was obtained.

### Example 10

Example 10 was performed similarly to Example 5, except that Fe₂O₃ fine particles having an average particle diameter of 20 nm were used.

Fe₂O₃ fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.9 dB (as the SNR value of the medium) was obtained.

### Example 11

Example 11 was performed similarly to Example 5, except that Co fine particles having an average particle diameter of 17.5 nm were used.

Co fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.8 dB (as the SNR value of the medium) was obtained.

### Example 12

Example 12 was performed similarly to Example 5, except that Ni fine particles having an average particle diameter of 15.5 nm were used.

Ni fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 13.1 dB (as the SNR value of the medium) was obtained.

### Example 13

Example 13 was performed similarly to Example 5, except that Cu fine particles having an average particle diameter of 6.8 nm were used.

Cu fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12 dB (as the SNR value of the medium) was obtained.

### Example 14

Example 14 was performed similarly to Example 5, except that Zn fine particles having an average particle diameter of 17.4 nm were used.

Zn fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.5 dB (as the SNR value of the medium) was obtained.

### Example 15

Example 15 was performed similarly to Example 5, except that Zr fine particles having an average particle diameter of 15.3 nm were used.

Ar fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.7 dB (as the SNR value of the medium) was obtained.

### Example 16

Example 16 was performed similarly to Example 5, except that Mo fine particles having an average particle diameter of 12.7 nm were used.

Mo fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12 dB (as the SNR value of the medium) was obtained.

### Example 17

Example 17 was performed similarly to Example 5, except that Ru fine particles having an average particle diameter of 19.9 nm were used.

Ru fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.8 dB (as the SNR value of the medium) was obtained.

### Example 18

Example 18 was performed similarly to Example 5, except that PdSi fine particles having an average particle diameter of 18.9 nm were used.

PdSi fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.1 dB (as the SNR value of the medium) was obtained.

### Example 19

Example 19 was performed similarly to Example 5, except that Ag fine particles having an average particle diameter of 9.7 nm were used.

Ag fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12 dB (as the SNR value of the medium) was obtained.

### Example 20

Example 20 was performed similarly to Example 5, except that Ta fine particles having an average particle diameter of 15.3 nm were used.

Ta fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 11.8 dB (as the SNR value of the medium) was obtained.

### Example 21

Example 21 was performed similarly to Example 5, except that W fine particles having an average particle diameter of 10.8 nm were used.

W fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12 dB (as the SNR value of the medium) was obtained.

### Example 22

Example 22 was performed similarly to Example 5, except that Pt fine particles having an average particle diameter of 18 nm were used.

Pt fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 11.9 dB (as the SNR value of the medium) was obtained.

### Example 23

Example 23 was performed similarly to Example 5, except that Ce fine particles having an average particle diameter of 19.9 nm were used.

Ce fine particles were formed on the mask layer by spin coating. Thereafter, the formation of the overcoat layer and the irradiation with energy beams were sequentially performed. Further, the concave-convex pattern of metal fine particles was transferred to the mask layer and the magnetic recording layer to obtain a magnetic recording medium having a concave/convex pattern. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12 dB (as the SNR value of the medium) was obtained.

Hereinafter, Examples 24 to 41 were performed similarly to Example 5 except that the material of the overcoat layer was variously changed.

### Example 24

In Example 24, Au was used for the metal fine particles and Al was used for the overcoat layer. An Al film was formed by the DC sputtering method under the conditions of gas pressure of 0.7 Pa, gas mass flow of 35 sccm, and power supply of 500 W so as to have a thickness of 3 nm from the metal fine particle surface.

The removal of the Al overcoat layer was performed by inductively-coupled plasma etching. The Al overcoat layer was removed from the top of the metal fine particle layer by etching under the conditions of etchant of Cl₂, gas pressure of 0.1 Pa, antenna power of 50 W, and bias power of 10 W for 5 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.8 dB (as the SNR value of the medium) was obtained.

### Example 25

Example 25 was performed similarly to Example 5 except that the overcoat layer was Si.

An Si film was formed by the DC sputtering method under the conditions of gas pressure of 0.7 Pa, gas mass flow of 35 sccm, and power supply of 500 W so as to have a thickness of 3 nm from the metal fine particle surface.

The removal of the Si overcoat layer was performed by inductively-coupled plasma etching. The Si overcoat layer was removed from the top of the metal fine particle layer by etching under the conditions of etchant of CF₄, gas pressure of 0.1 Pa, antenna power of 50 W, and bias power of 5 W for 5 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 11.3 dB (as the SNR value of the medium) was obtained.

### Example 26

Example 26 was performed similarly to Example 5 except that the overcoat layer was Ti.

A Ti film was formed by the DC sputtering method under the conditions of gas pressure of 0.7 Pa, gas mass flow of 35 sccm, and power supply of 500 W so as to have a thickness of 3 nm from the metal fine particle surface.

The removal of the Ti overcoat layer was performed by ion milling using Ar. The Ti overcoat layer was removed from the top of the metal fine particle layer by milling under the conditions of gas pressure of 0.1 Pa and accelerating voltage of 300 V for 15 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.3 dB (as the SNR value of the medium) was obtained.

### Example 27

Example 27 was performed similarly to Example 5 except that the overcoat layer was Fe.

A Fe film was formed by the DC sputtering method under the conditions of gas pressure of 0.7 Pa, gas mass flow of 35 sccm, and power supply of 500 W so as to have a thickness of 3 nm from the metal fine particle surface.

The removal of the Fe overcoat layer was performed by ion milling using Ar. The Fe overcoat layer was removed from the top of the metal fine particle layer by milling under the conditions of gas pressure of 0.1 Pa and accelerating voltage of 300 V for 13 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.5 dB (as the SNR value of the medium) was obtained.

### Example 28

Example 28 was performed similarly to Example 5 except that the overcoat layer was Co.

A Co film was formed by the DC sputtering method under the conditions of gas pressure of 0.7 Pa, gas mass flow of 35 sccm, and power supply of 500 W so as to have a thickness of 3 nm from the metal fine particle surface.

The removal of the Co overcoat layer was performed by ion milling using Ar. The Co overcoat layer was removed from the top of the metal fine particle layer by milling under the conditions of gas pressure of 0.1 Pa and accelerating voltage of 300 V for 8 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 11.9 dB (as the SNR value of the medium) was obtained.

### Example 29

Example 29 was performed similarly to Example 5 except that the overcoat layer was Ni.

A Ni film was formed by the DC sputtering method under the conditions of gas pressure of 0.7 Pa, gas mass flow of 35 sccm, and power supply of 500 W so as to have a thickness of 3 nm from the metal fine particle surface.

The removal of the Ni overcoat layer was performed by ion milling using Ar. The Ni overcoat layer was removed from the top of the metal fine particle layer by milling under the conditions of gas pressure of 0.1 Pa and accelerating voltage of 300 V for 13 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.6 dB (as the SNR value of the medium) was obtained.

### Example 30

Example 30 was performed similarly to Example 5 except that the overcoat layer was Cu.

A Cu film was formed by the DC sputtering method under the conditions of gas pressure of 0.7 Pa, gas mass flow of 35 sccm, and power supply of 500 W so as to have a thickness of 3 nm from the metal fine particle surface.

The removal of the Cu overcoat layer was performed by ion milling using Ar. The Cu overcoat layer was removed from the top of the metal fine particle layer by milling under the conditions of gas pressure of 0.1 Pa and accelerating voltage of 300 V for 7 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.8 dB (as the SNR value of the medium) was obtained.

### Example 31

Example 31 was performed similarly to Example 5 except that the overcoat layer was Zn.

A Zn film was formed by the DC sputtering method under the conditions of gas pressure of 0.7 Pa, gas mass flow of 35 sccm, and power supply of 500 W so as to have a thickness of 3 nm from the metal fine particle surface.

The removal of the Zn overcoat layer was performed by ion milling using Ar. The Zn overcoat layer was removed from the top of the metal fine particle layer by milling under the conditions of gas pressure of 0.1 Pa and accelerating voltage of 300 V for 7 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.4 dB (as the SNR value of the medium) was obtained.

### Example 32

Example 32 was performed similarly to Example 5 except that the overcoat layer was Zr.

A Zr film was formed by the DC sputtering method under the conditions of gas pressure of 0.7 Pa, gas mass flow of 35 sccm, and power supply of 500 W so as to have a thickness of 3 nm from the metal fine particle surface.

The removal of the Zr overcoat layer was performed by ion milling using Ar. The Zr overcoat layer was removed from the top of the metal fine particle layer by milling under the conditions of gas pressure of 0.1 Pa and accelerating voltage of 300 V for 10 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.2 dB (as the SNR value of the medium) was obtained.

### Example 33

Example 33 was performed similarly to Example 5 except that the overcoat layer was Mo.

An Mo film was formed by the DC sputtering method under the conditions of gas pressure of 0.7 Pa, gas mass flow of 35 sccm, and power supply of 500 W so as to have a thickness of 3 nm from the metal fine particle surface.

The removal of the Mo overcoat layer was performed by ion milling using Ar. The Mo overcoat layer was removed from the top of the metal fine particle layer by milling under the conditions of gas pressure of 0.1 Pa and accelerating voltage of 300 V for 15 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12 dB (as the SNR value of the medium) was obtained.

### Example 34

Example 34 was performed similarly to Example 5 except that the overcoat layer was Ru.

A Ru film was formed by the DC sputtering method under the conditions of gas pressure of 0.7 Pa, gas mass flow of 35 sccm, and power supply of 500 W so as to have a thickness of 3 nm from the metal fine particle surface.

The removal of the Ru overcoat layer was performed by ion milling using Ar. The Ru overcoat layer was removed from the top of the metal fine particle layer by milling under the conditions of gas pressure of 0.1 Pa and accelerating voltage of 300 V for 11 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 11.4 dB (as the SNR value of the medium) was obtained.

### Example 35

Example 35 was performed similarly to Example 5 except that the overcoat layer was Pd.

A Pd film was formed by the DC sputtering method under the conditions of gas pressure of 0.7 Pa, gas mass flow of 35 sccm, and power supply of 500 W so as to have a thickness of 3 nm from the metal fine particle surface.

The removal of the Pd overcoat layer was performed by ion milling using Ar. The Pd overcoat layer was removed from the top of the metal fine particle layer by milling under the conditions of gas pressure of 0.1 Pa and accelerating voltage of 300 V for 12 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.8 dB (as the SNR value of the medium) was obtained.

### Example 36

Example 36 was performed similarly to Example 5 except that the overcoat layer was Ag.

An Ag film was formed by the DC sputtering method under the conditions of gas pressure of 0.7 Pa, gas mass flow of 35 sccm, and power supply of 500 W so as to have a thickness of 3 nm from the metal fine particle surface.

The removal of the Ag overcoat layer was performed by ion milling using Ar. The Ag overcoat layer was removed from the top of the metal fine particle layer by milling under the conditions of gas pressure of 0.1 Pa and accelerating voltage of 300 V for 8 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.3 dB (as the SNR value of the medium) was obtained.

### Example 37

Example 37 was performed similarly to Example 5 except that the overcoat layer was Ta.

A Ta film was formed by the DC sputtering method under the conditions of gas pressure of 0.7 Pa, gas mass flow of 35 sccm, and power supply of 500 W so as to have a thickness of 3 nm from the metal fine particle surface.

The removal of the Ta overcoat layer was performed by inductively-coupled plasma etching. The Ta overcoat layer was removed from the top of the metal fine particle layer by etching under the conditions of etchant of CF₄, gas pressure of 0.1 Pa, antenna power of 50 W, and bias power of 5 W for 8 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 11 dB (as the SNR value of the medium) was obtained.

### Example 38

Example 38 was performed similarly to Example 5 except that the overcoat layer was W.

A W film was formed by the DC sputtering method under the conditions of gas pressure of 0.7 Pa, gas mass flow of 35 sccm, and power supply of 500 W so as to have a thickness of 3 nm from the metal fine particle surface.

The removal of the W overcoat layer was performed by inductively-coupled plasma etching. The W overcoat layer was removed from the top of the metal fine particle layer by etching under the conditions of etchant of CF₄, gas pressure of 0.1 Pa, antenna power of 50 W, and bias power of 5 W for 9 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 10.2 dB (as the SNR value of the medium) was obtained.

### Example 39

Example 39 was performed similarly to Example 5 except that the overcoat layer was Pt.

A Pt film was formed by the DC sputtering method under the conditions of gas pressure of 0.7 Pa, gas mass flow of 35 sccm, and power supply of 500 W so as to have a thickness of 3 nm from the metal fine particle surface.

The removal of the Pt overcoat layer was performed by ion milling using Ar. The Pt overcoat layer was removed from the top of the metal fine particle layer by milling under the conditions of gas pressure of 0.1 Pa and accelerating voltage of 300 V for 10 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.4 dB (as the SNR value of the medium) was obtained.

### Example 40

Example 40 was performed similarly to Example 5 except that the overcoat layer was Ce.

A Ce film was formed by the DC sputtering method under the conditions of gas pressure of 0.7 Pa, gas mass flow of 35 sccm, and power supply of 500 W so as to have a thickness of 3 nm from the metal fine particle surface.

The removal of the Ce overcoat layer was performed by ion milling using Ar. The Ce overcoat layer was removed from the top of the metal fine particle layer by milling under the conditions of gas pressure of 0.1 Pa and accelerating voltage of 300 V for 12 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.8 dB (as the SNR value of the medium) was obtained.

### Example 41

Example 41 was performed similarly to Example 5 except that the overcoat layer was Ge.

A Ge film was formed by the DC sputtering method under the conditions of gas pressure of 0.7 Pa, gas mass flow of 35 sccm, and power supply of 500 W so as to have a thickness of 3 nm from the metal fine particle surface.

The removal of the Ge overcoat layer was performed by inductively-coupled plasma etching. The Ge overcoat layer was removed from the top of the metal fine particle layer by etching under the conditions of etchant of CF₄, gas pressure of 0.1 Pa, antenna power of 50 W, and bias power of 5 W for 5 seconds.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 11 dB (as the SNR value of the medium) was obtained.

Hereinafter, examples in which the metal fine particles are Au, and the material and film thickness of the overcoat layer are changed are shown in Examples 42 to 45.

### Example 42

Example 42 was performed similarly to Example 5 except that C was used for the overcoat layer and the film thickness was 1 nm.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.8 dB (as the SNR value of the medium) was obtained.

### Example 43

Example 43 was performed similarly to Example 5 except that C was used for the overcoat layer and the film thickness was 5 nm.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 11.9 dB (as the SNR value of the medium) was obtained.

### Example 44

Example 44 was performed similarly to Example 5 except that Si was used for the overcoat layer and the film thickness was 1 nm.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 11.8 dB (as the SNR value of the medium) was obtained.

### Example 45

Example 45 was performed similarly to Example 5 except that Si was used for the overcoat layer and the film thickness was 5 nm.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.2 dB (as the SNR value of the medium) was obtained.

Hereinafter, Examples 46 to 47 are examples in which Au is used for the metal fine particle material and the particles have different average particle diameters.

### Example 46

Example 46 was performed similarly to Example 5 except that Au fine particles having an average particle diameter of 15 nm were used and the thickness of the C overcoat layer was 5 nm.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 8 dB (as the SNR value of the medium) was obtained.

### Example 47

Example 47 was performed similarly to Example 5 except that Au fine particles having an average particle diameter of 50 nm were used and the thickness of the C overcoat layer was 5 nm.

After that, the energy ray irradiation was performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 3.3 dB (as the SNR value of the medium) was obtained.

### Example 48

Example 48 is an example in which a nanoimprint stamper is produced using a substrate in which metal fine particles are patterned as the master disc, and a concave-convex pattern is formed by nanoimprint lithography using the nanoimprint stamper.

The process for the metal fine particles, the process for the mask layer, the process for the overcoat material, and the process for irradiation with energy beams were the same as those in Example 5.

In order to produce a nanoimprint stamper, a master disc was produced. A mask layer was formed on the substrate similarly to Example 5, using a general-purpose-6-inch Si wafer as the substrate. Thereafter, the mask layer was coated with Au particles having an average particle diameter of 8 nm and a metal fine particle layer was formed on the substrate. Then, the formation of an overcoat layer and the irradiation with energy beams were sequentially performed. A concave-convex pattern was formed on the substrate by etching the layer.

The master disc was produced using the nanoimprint stamper. In order to perform a conductive treatment on the concave-convex patterns, the Ni film was formed by the DC sputtering method. The concave-convex pattern was uniformly coated with a Ni conductive film having a thickness of 52 nm under the conditions of ultimate vacuum of 8.0×10⁻⁴ Pa, Ar gas pressure of 1.0 Pa, and DC power supply of 200 W. In place of the Ni film, it is possible to use Ni—P and Ni—B alloys formed by vacuum deposition or electroless plating, in addition to the sputtering method as the method for forming the conductive film. In order to easily peel the stamper, the surface may be oxidized after the formation of the conductive film.

Subsequently, a Ni film is formed along with the concave-convex pattern by electroforming. A highly concentrated nickel sulfamate plating solution (NS-169, manufactured by Showa chemical Co., Ltd.) was used for an electroforming solution. Under electroforming conditions: nickel sulfamate: 600 g/L, boric acid: 40 g/L, sodium lauryl sulfate surfactant: 0.15 g/L, solution temperature: 55° C., pH: 3.8 to 4.0, and energized current density: 20 A/dm², a Ni stamper having a thickness of 300 μm was produced. A nanoimprint stamper having a concave-convex pattern can be obtained by demolding the Ni stamper from the master disc. When residues and particles are present on the convexo-concave pattern of the stamper after demolding, residues and particles can be removed by etching the concave-convex pattern, if necessary and the stamper can be removed. Thus, the stamper can be cleaned. Finally, the electroformed Ni plate was punched into a disk shape having a diameter of 2.5 inch and processed to obtain a Ni stamper.

The Ni stamper was subjected to an injection molding treatment and the resin stamper was duplicated. A cyclic olefin polymer (manufactured by ZEON CORPORATION (ZEONOR 1060R)) was used for the resin material.

A concave-convex pattern was formed on a resist layer using the resin stamper thus obtained. First, an ultraviolet cured resist was spin-coated on a medium sample to have a thickness of 40 nm and the resulting layer was used as the resist layer. Subsequently, the resin stamper was imprinted on the resist layer, and the resist layer was cured by irradiating with ultraviolet rays (irradiating with ultraviolet rays in a state where the ultraviolet cured resin layer was pressed by the resin stamper). The resin stamper was released from the cured resist layer to obtain a desired dot pattern.

The resist residues accompanied by imprinting were present in the groove portion of the concave-convex pattern of the sample, and thus they were removed by etching. The removal of the resist residues was performed by the plasma etching with O₂ etchant. The resist residues were removed by etching under the conditions of O₂ mass flow of 5 sccm, pressure of 0.1 Pa, power supply of 100 W, and bias power of 10 W for 8 seconds.

Similarly to Example 5, the metal fine particle layer was formed on the substrate having the magnetic recording layer and the mask layer thereon. The formation of an overcoat layer and the irradiation with energy beams were sequentially performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.4 dB (as the SNR value of the medium) was obtained.

### Example 49

Example 49 was performed similarly to Example 5 except that a release layer was formed between the magnetic recording layer and the mask layer.

In this example, an example in which the wet etching using an acid is assumed and Mo is used as a soluble metal release layer will be shown.

An Mo release layer was formed by the DC sputtering method. The ultimate pressure was set to 0.7 Pa, the power supply was set to 500 W, and Mo with a thickness of 5 nm was used to form the release layer on the magnetic recording layer. The process of transferring the concave-convex pattern to the release layer was performed by ion milling using Ar, similarly to the case of the magnetic recording layer. The milling time was set to 90 seconds and the pattern was transferred.

The concave-convex pattern was transferred, and then the release layer was dissolved and removed by wet etching. In the process, the magnetic recording layer was immersed in 0.1 wt % of a hydrogen peroxide solution for 5 minutes and scrub-washed to remove the mask layer from the top of the magnetic recording layer. Finally, the surface of the medium was washed with running ultrapure water.

The flying height of the head of the obtained magnetic recording medium was measured with the glide height tester and the flying-characteristics were evaluated. As a result, the measurement height exceeded a flying height of 10 nm which is the standard required to perform the read/write evaluation process. The signal/noise ratio of the medium was measured using the spin stand. As a result, a value of 12 dB (as the SNR value of the medium) was obtained.

### Comparative Example 1

Comparative example 1 is an example in which a diblock copolymer is used in place of metal fine particles as the material of the concave-convex pattern to be formed on the mask layer.

The diblock copolymer film is formed of two different types of polymers. A microphase-separated pattern is formed in the film by applying an external energy to the film. The formation of the magnetic recording layer of the present example, the release layer, and the mask layer and the processing conditions of those layers are the same as Example 49.

A block copolymer solution was first applied onto a carbon film. As the block copolymer solution, a solution prepared by dissolving a block copolymer of polystyrene and polydimethylsiloxane in a coating solvent was used. The molecular weights of the polystyrene block and the polydimethylsiloxane block are 11800 and 2000, respectively. A spherical microphase-separated structure having a pattern pitch of 13 nm is obtained from this composition. That is, a spherical polydimethylsiloxane pattern has an independent structure in a sea-like polystyrene pattern. Propylene glycol monomethyl ether acetate was used as the solvent to prepare a polymer solution having a percentage by weight concentration of 1.5%.

The solution was dripped onto a carbon film mask. The spin coating was performed at a rotating speed of 5000 rpm and a self-assembled film was formed using a single self-assembled film having a thickness of 15 nm. The single self-assembled film does not have a layered structure on the same flat surface of the medium, and means that the microphase-separated pattern of the sea-like polystyrene and the spherical polydimethylsiloxane is single-layered.

Further, the sea-like polystyrene and the spherical polydimethylsiloxane dot pattern are microphase-separated in the self-assembled film and thus thermal annealing was performed. In the thermal annealing, annealing was performed at 170° C. for 12 hours (in a reduced pressure atmosphere, furnace pressure: 0.2 Pa) using a vacuum furnace to form a microphase-separated structure having a pitch dot of 13 nm in the self-assembled film.

Then, etching was performed using the phase-separated pattern as a base pattern to form a concave-convex pattern. The etching was performed by inductively coupled plasma reactive ion etching. The process gas pressure was set to 0.1 Pa, and the gas mass flow was set to 5 sccm.

In order to remove polydimethylsiloxane of the surface layer of the self-assembled film, etching using CF₄ gas as an etchant was performed under the conditions of antenna power of 50 W and bias power of 5 W for 7 seconds. Subsequently, in order to transfer the concave-convex pattern to the sea-like polystyrene and the C film of the lower portion of the self-assembled film, etching using O₂ gas as an etchant was performed under conditions of antenna power of 100 W and bias power of 5 W for 110 seconds. Since the O₂ etchant used for the removal of polystyrene etches the C film at the lower portion, the Si transfer layer becomes a stopper layer to stop the etching. Similarly to Example 1, etching was performed on the Si transfer layer at the lower portion and the C mask layer by plasma etching using the CF₄ etchant and the O₂ etchant to transfer the concave-convex pattern of the self-assembled film to the mask layer.

Similarly to Example 1, the metal fine particle layer was formed on the substrate having the magnetic recording layer and the mask layer thereon. The formation of an overcoat layer and the irradiation with energy beams were sequentially performed. Further, the concave-convex pattern of metal fine particles was transferred to the mask layer and the magnetic recording layer to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12.1 dB (as the SNR value of the medium) was obtained. However, the tact time which is required for the formation of the concave-convex pattern, namely, the formation of the microphase-separated pattern of the self-assembled film and the transfer of the convexo-concave pattern is about 14 hours. It is very long as compared with the time when the metal fine particle is used (38 minutes). Thus, the production throughput is reduced.

### Comparative Example 2

Comparative example 2 relates to a method comprising transferring a concave-convex pattern formed on a resist layer by electron-beam lithography to a magnetic recording layer.

A 2.5 inch-diameter toroidal substrate was used as the substrate, and the magnetic recording layer was formed on the substrate by the DC sputtering method. Ar was used as the process gas, the gas pressure was set to 0.7 Pa, the gas mass flow was set to 35 sccm, and the power supply was set to 500 W. A 10-nm thick NiTa underlayer, a 4-nm thick Pd underlayer, a 20-nm thick Ru underlayer, and a 5-nm thick CoPt recording layer were formed in this order from the substrate side. Finally, a 3-nm thick Pd protective layer was formed to obtain a magnetic recording layer.

Subsequently, an underlayer for reducing the roughness of the release layer was formed on the magnetic recording layer. Here, the Pd film was selected and the layer was formed so as to have a thickness of 1.5 nm by the DC sputtering method. An Mo metal release layer was formed on the protective film so as to have a thickness of 5 nm by the DC sputtering method.

Then, the mask layer was formed on the release layer. Here, in order to transfer the concave-convex pattern of the resist layer with high resolution, a two-layered mask was used. As the first mask layer, a 30-nm-thick C film was formed from the substrate side. Further, as the transfer layer at the upper portion, a 5-nm-thick Si film and a 3-nm-thick C film were used. In the formation of each mask layer, a facing-targets sputtering system was used and each film was formed by spattering under the conditions of Ar gas flow rate of 35 sccm, Ar gas pressure of 0.7 Pa, and power supply of 500 W.

Then, a principal chain breaking-type electron beam positive resist for patterning was formed. As the electron beam resist, ZEP-520A (ZEON CORPORATION) was used. The resist was diluted in anisole as the solvent at a weight ratio of 1:3 (ZEP-520A:anisole) to prepare a diluted solution. Thereafter, the diluted solution was dropped onto the substrate. The substrate was spin-coated at a rotating speed of 5000 rpm so as to have a thickness of 10 nm. The sample was maintained on a vacuum hot plate heated to 180° C. for 150 seconds, and the electron beam resist was cured by prebaking.

Then, a pattern was drawn on the electron beam resist using an electron beam lithography system having a ZrO thermal field-emission electron source and beams with an accelerating voltage of 100 kV and a beam diameter of 2 nm. The electron beam lithography system is a so-called x-θ type lithographic system provided with signals used to form a writing pattern and with a one-way moving mechanism and rotating mechanism of a sample stage. In the drawing on the sample, the signals used to polarize electron beams are synchronized and the stage is moved in a radial direction. Here, a latent image of a dot/space pattern and line/space pattern at a pitch of 20 nm was formed on the electron beam resist under the conditions: drawing linear velocity: 0.15 m/sec, beam current value: 13 nA, and feed per revolution in the radial direction: 5 nm. The pattern area is a circumferential band area ranging from 20 to 22 mm in radius.

A concave-convex pattern (8 nm diameter dot/7 nm space) can be resolved by developing the pattern area. As the developer, an organic developer containing 100% normal amyl acetate as a component as was used. The electron beam resist was developed by immersing the sample in the solution for 20 seconds.

Then, the sample was rinsed by immersing the sample in isopropyl alcohol for 20 seconds. The surface of the sample was dried by directly blowing N₂.

Similarly to Example 49, the concave-convex pattern transfer was performed to the mask layer, the release layer, and the magnetic recording layer. The mask layer was removed from the top of the magnetic recording layer by the wet etching using an acid to obtain a magnetic recording medium having patterns. The flying height of the head from the obtained magnetic recording medium was measured with a glide height tester and flying characteristics were evaluated. As a result, the measurement height exceeded a flying height of 10 nm which is the standard required to perform the read/write evaluation process. The signal/noise ratio of the medium was measured using the spin stand. As a result, a value of 12 dB (as the SNR value of the medium) was obtained. However, the tact time which is required for the formation of the concave-convex pattern, namely, the formation of the microphase-separated pattern of the self-assembled film and the transfer of the convexo-concave pattern is about 183 hours. It is very long as compared with the time when the metal fine particle is used (38 minutes). Thus, the production throughput is reduced.

### Comparative Example 3

Comparative example 3 was performed similarly to Example 5 except that Au was used for the metal fine particles, the overcoat layer was not formed, and energy beam irradiation was not performed.

A cross section TEM image after the formation of the concave/convex portions of metal fine particles and a SEM image of the upper surface in the same state were observed. It was found that adjacent metal fine particles aggregated due to the disappearance of the protective coating around the fine particles during etching and the pattern accuracy was deteriorated. It was confirmed that the roughness difference between the concave-convex portions was significant and the transfer uniformity was deteriorated.

After the formation of the Au particle layer, the inductively-coupled plasma etching with O₂ etchant was performed. The etching was performed under the conditions of pressure of 0.1 Pa, gas mass flow of 20 sccm, power supply of 40 W, and bias power of 40 W for 5 seconds to transfer the pattern to the C mask.

The produced medium had a large roughness difference between the concave-convex portions. The flying characteristics were measured and they were judged as “NG”. It was found that the pattern transfer accuracy was significantly deteriorated.

### Comparative Example 4

Comparative example 4 was performed similarly to Example 5 except that Au was used for the metal fine particles, the overcoat layer was not formed, and energy beam irradiation was not performed.

The SEM image after the transfer of the pattern was confirmed. As a result, it was found that, similarly to Example 3, adjacent metal fine particles aggregated due to the disappearance of the protective coating around the fine particles during etching and the pattern accuracy was deteriorated. It was confirmed that the roughness difference between the concave-convex portions was significant and the transfer uniformity was deteriorated.

After the formation of the Au particle layer, the inductively-coupled plasma etching with O₂ etchant was performed. The etching was performed under the conditions of pressure of 0.1 Pa, gas mass flow of 20 sccm, power supply of 40 W, and bias power of 40 W for 5 seconds to transfer the pattern to the C mask.

The produced medium had a large roughness difference between the concave-convex portions. The flying characteristics were measured and they were judged as “NG”. It was found that the pattern transfer accuracy was significantly deteriorated.

### Comparative Example 5

Comparative example 5 was performed similarly to Example 5 except that Au was used for the metal fine particles, the overcoat layer was not formed, and energy beam irradiation was not performed.

The SEM image after the transfer of the pattern was confirmed. As a result, it was found that, similarly to Example 3, adjacent metal fine particles aggregated due to the disappearance of the protective coating around the fine particles during etching and the pattern accuracy was deteriorated. It was confirmed that the roughness difference between the concave-convex portions was significant and the transfer uniformity was deteriorated.

After the formation of the Au particle layer, the inductively-coupled plasma etching with O₂ etchant was performed. The etching was performed under the conditions of pressure of 0.1 Pa, gas mass flow of 20 sccm, power supply of 40 W, and bias power of 40 W for 5 seconds to transfer the pattern to the C mask.

The produced medium had a large roughness difference between the concave-convex portions. The flying characteristics were measured and they were judged as “NG”. It was found that the pattern transfer accuracy was significantly deteriorated.

### Comparative Example 6

Comparative example 6 was performed similarly to Example 5 except that Au was used for the metal fine particles and the thickness of the C overcoat layer was 10 nm.

The SEM image after the transfer of the pattern was confirmed. As a result, it was found that, similarly to Example 3, adjacent metal fine particles aggregated due to the disappearance of the protective coating around the fine particles during etching and the pattern accuracy was deteriorated. It was confirmed that the roughness difference between the concave-convex portions was significant and the transfer uniformity was deteriorated.

After the formation of the Au particle layer, the inductively-coupled plasma etching with O₂ etchant was performed. The etching was performed under the conditions of pressure of 0.1 Pa, gas mass flow 20 sccm, power supply 40 W, and bias power 40 W for 12 seconds to transfer the pattern to the C mask.

The produced medium had a large roughness difference between the concave-convex portions. The flying characteristics were measured and they were judged as “NG”. It was found that the pattern transfer accuracy was significantly deteriorated.

### Comparative Example 7

Comparative example 7 was performed similarly to Example 6 except that Au was used for the metal fine particles and the thickness of the Si overcoat layer was 10 nm.

The SEM image after the transfer of the pattern was confirmed. As a result, it was found that, similarly to Example 3, adjacent metal fine particles aggregated due to the disappearance of the protective coating around the fine particles during etching and the pattern accuracy was deteriorated. It was confirmed that the roughness difference between the concave-convex portions was significant and the transfer uniformity was deteriorated.

After the formation of the Au particle layer, the inductively-coupled plasma etching with CF₄ etchant was performed. The etching was performed under the conditions of pressure of 0.1 Pa, gas mass flow of 20 sccm, power supply of 100 W, and bias power of 30 W for 9 seconds to transfer the pattern to the C mask.

The produced medium had a large roughness difference between the concave-convex portions. The flying characteristics were measured and they were judged as “NG”. It was found that the pattern transfer accuracy was significantly deteriorated.

The results of the examples and comparative examples are shown in Table 1 to 4.

TABLE 1

| | Metal fine particles | | Overcoat | | | Glide | | |
|---|---|---|---|---|---|---|---|---|
| | | Average particle | | Film thickness | | evaluation | SNR | Processing |
| Examples | Materials | diameter (nm) | Materials | (nm) | Energy beams | results | (dB) | method |
| 1 | Au | 8 | C | 3 | UV in vacuo | 10-nm | 12.4 | Only mask |
| | | | | | | floating pass | | layer |
| 2 | Au | 8 | C | 3 | UV in an N₂ | 10-nm | 12.5 | Only mask |
| | | | | | atmosphere | floating pass | | layer |
| 3 | Au | 8 | C | 3 | UV in an Ar | 10-nm | 12.7 | Only mask |
| | | | | | atmosphere | floating pass | | layer |
| 4 | Au | 8 | C | 3 | Irradiation with | 10-nm | 12 | Only mask |
| | | | | | electron beams | floating pass | | layer |
| 5 | Au | 8 | C | 3 | UV in vacuo | 10-nm | 12.1 | Mask/transfer |
| | | | | | | floating pass | | layer |
| 6 | C | 8.2 | C | 3 | ↑ | 10-nm | 12.3 | ↑ |
| | | | | | | floating pass | | |
| 7 | Al | 15.3 | C | 3 | ↑ | 10-nm | 12.2 | ↑ |
| | | | | | | floating pass | | |
| 8 | Si | 19.8 | C | 3 | ↑ | 10-nm | 12.4 | ↑ |
| | | | | | | floating pass | | |
| 9 | Ti | 19.3 | C | 3 | ↑ | 10-nm | 12 | ↑ |
| | | | | | | floating pass | | |
| 10 | Fe₂O₃ | 20 | C | 3 | ↑ | 10-nm | 12.9 | ↑ |
| | | | | | | floating pass | | |
| 11 | Co | 17.5 | C | 3 | ↑ | 10-nm | 12.8 | ↑ |
| | | | | | | floating pass | | |
| 12 | Ni | 15.5 | C | 3 | ↑ | 10-nm | 13.1 | ↑ |
| | | | | | | floating pass | | |
| 13 | Cu | 6.8 | C | 3 | ↑ | 10-nm | 12 | ↑ |
| | | | | | | floating pass | | |
| 14 | Zn | 17.4 | C | 3 | ↑ | 10-nm | 12.5 | ↑ |
| | | | | | | floating pass | | |
| 15 | Zr | 15.3 | C | 3 | ↑ | 10-nm | 12.7 | ↑ |
| | | | | | | floating pass | | |

TABLE 2

| | Metal fine particles | | Overcoat | | | Glide | | |
|---|---|---|---|---|---|---|---|---|
| | | Average particle | | Film thickness | | evaluation | SNR | Processing |
| Examples | Materials | diameter (nm) | Materials | (nm) | Energy beams | results | (dB) | method |
| 16 | Mo | 12.7 | C | 3 | UV in vacuo | 10-nm | 12 | Mask/transfer |
| | | | | | | floating pass | | layer |
| 17 | Ru | 19.9 | C | 3 | ↑ | 10-nm | 12.8 | ↑ |
| | | | | | | floating pass | | |
| 18 | PdSi | 18.9 | C | 3 | ↑ | 10-nm | 12.1 | ↑ |
| | | | | | | floating pass | | |
| 19 | Ag | 9.7 | C | 3 | ↑ | 10-nm | 12 | ↑ |
| | | | | | | floating pass | | |
| 20 | Ta | 15.3 | C | 3 | ↑ | 10-nm | 11.8 | ↑ |
| | | | | | | floating pass | | |
| 21 | W | 10.8 | C | 3 | ↑ | 10-nm | 12 | ↑ |
| | | | | | | floating pass | | |
| 22 | Pt | 18 | C | 3 | ↑ | 10-nm | 11.9 | ↑ |
| | | | | | | floating pass | | |
| 23 | Ce | 19.9 | C | 3 | ↑ | 10-nm | 12 | ↑ |
| | | | | | | floating pass | | |
| 24 | Au | 8 | Al | 3 | ↑ | 10-nm | 12.8 | ↑ |
| | | | | | | floating pass | | |
| 25 | Au | 8 | Si | 3 | ↑ | 10-nm | 11.3 | ↑ |
| | | | | | | floating pass | | |
| 26 | Au | 8 | Ti | 3 | ↑ | 10-nm | 12.3 | ↑ |
| | | | | | | floating pass | | |
| 27 | Au | 8 | Fe | 3 | ↑ | 10-nm | 12.5 | ↑ |
| | | | | | | floating pass | | |
| 28 | Au | 8 | Co | 3 | ↑ | 10-nm | 11.9 | ↑ |
| | | | | | | floating pass | | |
| 29 | Au | 8 | Ni | 3 | ↑ | 10-nm | 12.6 | ↑ |
| | | | | | | floating pass | | |
| 30 | Au | 8 | Cu | 3 | ↑ | 10-nm | 12.8 | ↑ |
| | | | | | | floating pass | | |

TABLE 3

| | Metal fine particles | | Overcoat | | | Glide | | |
|---|---|---|---|---|---|---|---|---|
| | | Average particle | | Film thickness | | evaluation | SNR | Processing |
| Examples | Materials | diameter (nm) | Materials | (nm) | Energy beams | results | (dB) | method |
| 31 | Au | 8 | Zn | 3 | UV in vacuo | 10-nm | 12.4 | Mask/transfer |
| | | | | | | floating pass | | layer |
| 32 | Au | 8 | Zr | 3 | ↑ | 10-nm | 12.2 | ↑ |
| | | | | | | floating pass | | |
| 33 | Au | 8 | Mo | 3 | ↑ | 10-nm | 12 | ↑ |
| | | | | | | floating pass | | |
| 34 | Au | 8 | Ru | 3 | ↑ | 10-nm | 11.4 | ↑ |
| | | | | | | floating pass | | |
| 35 | Au | 8 | Pd | 3 | ↑ | 10-nm | 12.8 | ↑ |
| | | | | | | floating pass | | |
| 36 | Au | 8 | Ag | 3 | ↑ | 10-nm | 12.3 | ↑ |
| | | | | | | floating pass | | |
| 37 | Au | 8 | Ta | 3 | ↑ | 10-nm | 11 | ↑ |
| | | | | | | floating pass | | |
| 38 | Au | 8 | W | 3 | ↑ | 10-nm | 10.2 | ↑ |
| | | | | | | floating pass | | |
| 39 | Au | 8 | Pt | 3 | ↑ | 10-nm | 12.4 | ↑ |
| | | | | | | floating pass | | |
| 40 | Au | 8 | Ce | 3 | ↑ | 10-nm | 12.8 | ↑ |
| | | | | | | floating pass | | |
| 41 | Au | 8 | Ge | 3 | ↑ | 10-nm | 11 | ↑ |
| | | | | | | floating pass | | |
| 42 | Au | 8 | C | 1 | ↑ | 10-nm | 12.8 | ↑ |
| | | | | | | floating pass | | |
| 43 | Au | 8 | C | 5 | ↑ | 10-nm | 11.9 | ↑ |
| | | | | | | floating pass | | |
| 44 | Au | 8 | Si | 1 | ↑ | 10-nm | 11.8 | ↑ |
| | | | | | | floating pass | | |
| 45 | Au | 8 | Si | 5 | ↑ | 10-nm | 12.2 | ↑ |
| | | | | | | floating pass | | |

TABLE 4

| | Metal fine particles | | Overcoat | | | | | |
|---|---|---|---|---|---|---|---|---|
| | | Average | | Film | | Glide | | |
| | | particle | | thickness | | evaluation | SNR | Processing |
| | Materials | diameter (nm) | Materials | (nm) | Energy beams | results | (dB) | method |
| Examples | | | | | | | | |
| 46 | Au | 15 | C | 5 | UV in vacuo | 10-nm | 8 | Mask/transfer |
| | | | | | | floating pass | | layer |
| 47 | Au | 50 | C | 5 | ↑ | 10-nm | 3.3 | ↑ |
| | | | | | | floating pass | | |
| 48 | Au | 8 | C | 3 | ↑ | 10-nm | 12.4 | Nanoimprint |
| | | | | | | floating pass | | |
| 49 | Au | 8 | C | 3 | ↑ | 10-nm | 12 | Release layer/ |
| | | | | | | floating pass | | mask layer |
| Comparative | | | | | | | | |
| Examples | | | | | | | | |
| 1 | Diblock | — | — | — | — | 10-nm | 12.1 | Mask/transfer |
| | copolymer | | | | | floating pass | | layer |
| 2 | Electron | — | — | — | — | 10-nm | 12 | ↑ |
| | line-drawing | | | | | floating pass | | |
| 3 | Au | 8 | — | — | — | 10-nm | — | ↑ |
| | | | | | | floating NG | | |
| 4 | Au | 8 | C | 3 | — | 10-nm | — | ↑ |
| | | | | | | floating NG | | |
| 5 | Au | 8 | — | — | UV in vacuo | 10-nm | — | ↑ |
| | | | | | | floating NG | | |
| 6 | Au | 8 | C | 10 | ↑ | 10-nm | — | ↑ |
| | | | | | | floating NG | | |
| 7 | Au | 8 | Si | 10 | ↑ | 10-nm | — | ↑ |
| | | | | | | floating NG | | |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for producing a magnetic recording medium comprising:
forming a magnetic recording layer on a substrate;
forming a mask layer on the magnetic recording layer;
forming a metal fine particle layer formed of a plurality of metal fine particles coated with a protective coating on the mask layer;
forming an overcoat layer on the surface of the metal fine particle layer;
irradiating the metal fine particle layer with energy beams through the overcoat layer so as to deactivate the protective coating;
transferring a concave-convex pattern formed of the metal fine particle layer to the mask layer;
transferring the concave-convex pattern to the magnetic recording layer; and
removing the mask layer from the magnetic recording layer.

2. The method for producing a magnetic recording medium according to claim 1, wherein the metal fine particles are at least one kind selected from the group consisting of carbon, aluminium, silicon, titanium, iron, cobalt, nickel, copper, zinc, zirconium, molybdenum, ruthenium, palladium, silver, tantalum, tungsten, platinum, gold, cerium, the alloys thereof, and the compounds thereof.

3. The method for producing a magnetic recording medium according to claim 1, wherein the overcoat layer contains carbon or metal.

4. The method for producing a magnetic recording medium according to claim 1, wherein the method for coating the metal fine particle layer is selected from spin-coating, dip-coating, spin-casting, and ink-jetting.

5. The method for producing a magnetic recording medium according to claim 1, wherein a pattern transfer layer is further formed between the metal fine particle layer and the mask layer.

6. The method for producing a magnetic recording medium according to claim 1, wherein a release layer is further formed between the mask layer and the magnetic recording layer.

7. The method for producing a magnetic recording medium according to claim 1, wherein the protective coating is selected from the group consisting of alkane thiol, dodecanethiol, polyvinyl pyrrolidone, oleylamine, sodium polycarboxylate, and polycarboxylic acid ammonium.

8. A magnetic recording medium produced by a method comprising:
forming a magnetic recording layer on a substrate;
forming a mask layer on the magnetic recording layer;
forming a metal fine particle layer formed of metal fine particles coated with a protective coating on the mask layer;
forming an overcoat layer on the surface of the metal fine particle layer;
irradiating the metal fine particle layer with energy beams through the overcoat layer so as to deactivate the protective coating;
transferring a concave-convex pattern formed of the metal fine particle layer to the mask layer;
transferring the concave-convex pattern to the magnetic recording layer; and
removing the mask layer from the magnetic recording layer.

9. The magnetic recording medium according to claim 8, wherein the metal fine particles are at least one kind selected from the group consisting of carbon, aluminium, silicon, titanium, iron, cobalt, nickel, copper, zinc, zirconium, molybdenum, ruthenium, palladium, silver, tantalum, tungsten, platinum, gold, cerium, the alloys thereof, and the compounds thereof.

10. The magnetic recording medium according to claim 8, wherein the overcoat layer contains carbon or metal.

11. The magnetic recording medium according to claim 8, wherein the method for coating the metal fine particle layer is selected from spin-coating, dip-coating, spin-casting, and ink-jetting.

12. The magnetic recording medium according to claim 8, wherein a pattern transfer layer is further formed between the metal fine particle layer and the mask layer.

13. The magnetic recording medium according to claim 8, wherein a release layer is further formed between the mask layer and the magnetic recording layer.

14. The magnetic recording medium according to claim 8, wherein the protective coating is selected from the group consisting of alkane thiol, dodecanethiol, polyvinyl pyrrolidone, oleylamine, sodium polycarboxylate, and polycarboxylic acid ammonium.

15. A method for producing a stamper comprising:
forming a metal fine particle layer formed of metal fine particles coated with a protective coating on the mask layer;
forming an overcoat layer on the surface of the substrate and the metal fine particle layer;
irradiating the metal fine particle layer with energy beams through the overcoat layer so as to deactivate the protective coating;
forming a conductive layer having the concave-convex pattern on the concave-convex pattern formed of the metal fine particle film;
forming an electroformed layer using the conductive layer as an electrode; and
peeling off the conductive layer to form a stamper formed of the electroformed layer to which the concave-convex pattern is transferred.

16. The method for producing a stamper according to claim 15, further comprising:
forming a mask layer between the substrate and the metal fine particle coated layer;
transferring the concave-convex pattern to the mask layer before forming the conductive layer having the concave-convex pattern; and
forming the conductive layer having the concave-convex pattern on the concave-convex pattern formed of a single layer of the metal fine particle film and the mask layer.

17. A method for producing a magnetic recording medium comprising:
forming a metal fine particle layer formed of metal fine particles coated with a protective coating on the mask layer;
forming an overcoat layer on the surface of the metal fine particle layer;
irradiating the metal fine particle layer with energy beams through the overcoat layer so as to deactivate the protective coating;
forming a conductive layer having the concave-convex pattern on the concave-convex pattern formed of the metal fine particle film;
forming an electroformed layer using the conductive layer as an electrode; peeling off the conductive layer to form a stamper formed of the electroformed layer to which the concave-convex pattern is transferred;
forming a magnetic recording layer on the substrate, forming a mask layer on the magnetic recording layer;
forming an imprint resist layer on the mask layer;
transferring the concave-convex pattern to the imprint resist layer using the stamper;
transferring the concave-convex pattern to the mask layer; transferring the concave-convex pattern to the magnetic recording layer; and
removing the mask layer from the magnetic recording layer.

18. The method for producing a magnetic recording medium according to claim 17, further comprising:
forming a mask layer between the substrate and the metal fine particle coated layer;
transferring the concave-convex pattern to the mask layer before forming the conductive layer having the concave-convex pattern; and
forming the conductive layer having the concave-convex pattern on the concave-convex pattern formed of a single layer of the metal fine particle film and the mask layer.
